(19) United States
(12) Patent Application Publication
(10) Pub. No.: US 2026/0142183 A1
(43) Pub. Date: May 21, 2026

(54) Protected Sulfur Cathode for Alkali Metal-Sulfur Secondary Battery and Manufacturing Method

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/950,132

(22) Filed: Nov. 17, 2024

(51) Int. Cl. H01M 4/62; H01M 4/136; H01M 4/36; H01M 4/58; H01M 10/0525; H01M 10/054

(52) U.S. Cl. CPC H01M 4/628; H01M 4/136; H01M 4/366; H01M 4/5815; H01M 4/622; H01M 10/0525; H01M 10/054

(57) ABSTRACT

A sulfur cathode (and production process) for an alkali metal-sulfur cell, comprising: (i) a cathode active material layer comprising a resin binder, an optional conductive additive, and multiple particles of a sulfur-containing material selected from a sulfur-carbon hybrid, a sulfur-graphite hybrid, a sulfur-graphene hybrid, a conducting polymer-sulfur hybrid, a metal sulfide, a sulfur compound, or a combination thereof, wherein the sulfur-containing material particles are bonded by the resin binder to form an integral solid layer; and (ii) a cathode-protecting layer, comprising a first high-elasticity polymer, which covers and protects the integral solid layer wherein the high-elasticity polymer has a recoverable tensile strain no less than 10% when measured without an additive or reinforcement, a lithium ion conductivity no less than 10⁻⁶ S/cm at room temperature, and a thickness from 0.5 nm to 100 μm and the high-elasticity polymer preferably permeates into pores of the cathode active material layer.

### FIELD

The present invention provides a unique cathode composition and structure in a secondary or rechargeable alkali metal-sulfur battery, including the lithium-sulfur battery, sodium-sulfur battery, and potassium-sulfur battery. The lithium-sulfur battery can include the lithium metal-sulfur battery (having lithium metal as the anode active material and sulfur as the cathode active material) and the lithium ion-sulfur battery (e.g. Si or graphite as the anode active material and sulfur as the cathode active material). The sodium-sulfur battery can include the sodium metal-sulfur battery (having sodium metal as the anode active material and sulfur as the cathode active material) and the sodium ion-sulfur battery (e.g. hard carbon as the anode active material and sulfur as the cathode active material).

### BACKGROUND

Rechargeable lithium-ion (Li-ion) and lithium metal batteries (including Li-sulfur and Li metal-air batteries) are considered promising power sources for electric vehicle (EV), hybrid electric vehicle (HEV), and portable electronic devices, such as lap-top computers and mobile phones. Lithium as a metal element has the highest capacity (3,861 mAh/g) compared to any other metal or metal-intercalated compound as an anode active material (except Li_{4.4}Si, which has a specific capacity of 4,200 mAh/g). Hence, in general, Li metal batteries have a significantly higher energy density than lithium ion batteries.

Historically, rechargeable lithium metal batteries were produced using non-lithiated compounds having relatively high specific capacities, such as TiS₂, MoS₂, MnO₂, CoO₂, and V₂O₅, as the cathode active materials, which were coupled with a lithium metal anode. When the battery was discharged, lithium ions were transferred from the lithium metal anode through the electrolyte to the cathode, and the cathode became lithiated. Unfortunately, upon repeated charges/discharges, the lithium metal resulted in the formation of dendrites at the anode that ultimately grew to penetrate through the separator, causing internal shorting and explosion. As a result of a series of accidents associated with this problem, the production of these types of secondary batteries was stopped in the early 1990's, giving ways to lithium-ion batteries.

In lithium-ion batteries, pure lithium metal sheet or film was replaced by carbonaceous materials as the anode. The carbonaceous material absorbs lithium (through intercalation of lithium ions or atoms between graphene planes, for instance) and desorbs lithium ions during the re-charge and discharge phases, respectively, of the lithium ion battery operation. The carbonaceous material may comprise primarily graphite that can be intercalated with lithium and the resulting graphite intercalation compound may be expressed as LiₓC₆, where x is typically less than 1.

Although lithium-ion (Li-ion) batteries are promising energy storage devices for electric drive vehicles, state-of-the-art Li-ion batteries have yet to meet the cost and performance targets. Li-ion cells typically use a lithium transition-metal oxide or phosphate as a positive electrode (cathode) that de/re-intercalates Li⁺ at a high potential with respect to the carbon negative electrode (anode). The specific capacity of lithium transition-metal oxide or phosphate based cathode active material is typically in the range of 150-250 mAh/g. As a result, the specific energy of commercially available Li-ion cells is typically in the range of 150-250 Wh/kg. These specific energy values are two to three times lower than what would be required for battery-powered electric vehicles to be widely accepted.

With the rapid development of hybrid (HEV), plug-in hybrid electric vehicles (HEV), and all-battery electric vehicles (EV), there is an urgent need for anode and cathode materials that provide a rechargeable battery with a significantly higher specific energy, higher energy density, higher rate capability, long cycle life, and safety. One of the most promising energy storage devices is the lithium-sulfur (Li—S) cell since the theoretical capacity of Li is 3,861 mAh/g and that of S is 1,675 mAh/g. In its simplest form, a Li—S cell includes elemental sulfur as the positive electrode and lithium as the negative electrode. The lithium-sulfur cell operates with a redox couple, described by the reaction S₈+16Li↔8Li₂S that lies near 2.2 V with respect to Li⁺/Li^{o}. This electrochemical potential is approximately ⅔ of that exhibited by conventional positive electrodes (e.g. LiMnO₄). However, this shortcoming is offset by the very high theoretical capacities of both Li and S. Thus, compared with conventional intercalation-based Li-ion batteries, Li—S cells have the opportunity to provide a significantly higher energy density (a product of capacity and voltage). Assuming complete reaction to Li₂S, energy densities values can approach 2,500 Wh/kg and 2,800 Wh/l, respectively, based on the combined Li and S weight or volume. If based on the total cell weight or volume, the energy densities can reach approximately 1,000 Wh/kg and 1,100 Wh/l, respectively. However, the current Li-sulfur cells reported by industry leaders in sulfur cathode technology have a maximum cell specific energy of 250-400 Wh/kg (based on the total cell weight), which is far below what is possible.

In summary, despite its considerable advantages, the Li—S cell is plagued with several major technical problems that have thus far hindered its widespread commercialization:
(1) Conventional lithium metal cells still have dendrite formation and related internal shorting issues.
(2) Sulfur or sulfur-containing organic compounds are highly insulating, both electrically and ionically. To enable a reversible electrochemical reaction at high current densities or charge/discharge rates, the sulfur should maintain intimate contact with an electrically conductive additive. Various carbon-sulfur composites have been utilized for this purpose, but only with limited success owing to the limited scale of the contact area. Typical reported capacities are between 300 and 550 mAh/g (based on the cathode carbon-sulfur composite weight) at moderate rates.
(3) The cell tends to exhibit significant capacity decay during discharge-charge cycling. This is mainly due to the high solubility of the lithium polysulfide anions formed as reaction intermediates during both discharge and charge processes in the polar organic solvents used in electrolytes. During cycling, the lithium polysulfide anions can migrate through the separator to the Li negative electrode whereupon they are reduced to solid precipitates (Li₂S₂ and/or Li₂S), causing active mass loss. In addition, the solid product that precipitates on the surface of the positive electrode during discharge becomes electrochemically irreversible, which also contributes to active mass loss.
(4) More generally speaking, a significant drawback with cells containing cathodes comprising elemental sulfur, organosulfur and carbon-sulfur materials relates to the dissolution and excessive out-diffusion of soluble sulfides, polysulfides, organo-sulfides, carbon-sulfides and/or carbon-polysulfides (hereinafter referred to as anionic reduction products) from the cathode into the rest of the cell. This phenomenon is commonly referred to as the Shuttle Effect. This process leads to several problems: high self-discharge rates, loss of cathode capacity, corrosion of current collectors and electrical leads leading to loss of electrical contact to active cell components, fouling of the anode surface giving rise to malfunction of the anode, and clogging of the pores in the cell membrane separator which leads to loss of ion transport and large increases in internal resistance in the cell.

In response to these challenges, new electrolytes, protective films for the lithium anode, and solid electrolytes have been developed. Some interesting cathode developments have been reported recently to contain lithium polysulfides; but, their performance still fall short of what is required for practical applications.

For instance, Zhang, et al. (US Pub. No. 2014/0234702; Aug. 21, 2014) makes use of a chemical reaction method of depositing S particles on surfaces of isolated graphene oxide (GO) sheets. But, this method is incapable of creating a large proportion of ultra-small S particles on GO surfaces (i.e. typically <66% of S in the GO-S nanocomposite composition). The resulting Li—S cells also exhibit poor rate capability; e.g. the specific capacity of 1,100 mAh/g (based on S weight) at 0.02 C rate is reduced to <450 mAh/g at 1.0 C rate. It may be noted that the highest achievable specific capacity of 1,100 mAh/g represents a sulfur utilization efficiency of only 1,100/1,675=65.7% even at such a low charge/discharge rate (0.02 C means completing the charge or discharge process in 0/0.02=50 hours; 1 C=1 hour, 2 C=½ hours, and 3 C=⅓ hours, etc.) Further, such a S-GO nanocomposite cathode-based Li—S cell exhibits very poor cycle life, with the capacity typically dropping to less than 60% of its original capacity in less than 40 charge/discharge cycles. Such a short cycle life makes this Li—S cell not useful for any practical application. Another chemical reaction method of depositing S particles on graphene oxide surfaces is disclosed by Wang, et al. (US Pub. No. 2013/0171339; Jul. 4, 2013). This Li—S cell still suffers from the same problems.

A solution precipitation method was disclosed by Liu, et al. (US Pub. No. 2012/0088154; Apr. 12, 2012) to prepare graphene-sulfur nanocomposites (having sulfur particles adsorbed on GO surfaces) for use as the cathode material in a Li—S cell. The method entails mixing GO sheets and S in a solvent (CS₂) to form a suspension. The solvent is then evaporated to yield a solid nanocomposite, which is then ground to yield nanocomposite powder having primary sulfur particles with an average diameter less than approximately 50 nm. Unfortunately, this method does not appear to be capable of producing S particles less than 40 nm. The resulting Li—S cell exhibits very poor cycle life (a 50% decay in capacity after only 50 cycles). Even when these nanocomposite particles are encapsulated in a polymer, the Li—S cell retains less than 80% of its original capacity after 100 cycles. The cell also exhibits a poor rate capability (specific capacity of 1,050 mAh/g (S wt.) at 0.1 C rate, dropped to <580 mAh/g at 1.0 C rate). Again, this implies that a large proportion of S did not contribute to the lithium storage, resulting in a low S utilization efficiency.

Furthermore, all of the aforementioned methods involve depositing S particles onto surfaces of isolated graphene sheets. The presence of S particles (one of the most insulating materials) adhered to graphene surfaces would make the resulting electrode structure non-conducting when multiple S-bonded graphene sheets are packed together. These S particles prevent graphene sheets from contacting each other, making it impossible for otherwise conducting graphene sheets to form a 3-D network of electron-conducting paths in the cathode. This unintended and unexpected outcome is another reason why these prior art Li—S cells have performed so poorly.

Despite the various approaches proposed for the fabrication of high energy density Li—S cells, there remains a need for cathode materials, production processes, and cell operation methods that impede the out-diffusion of S or lithium polysulfide from the cathode compartments into other components in these cells, improve the utilization of electro-active cathode materials (S utilization efficiency), and provide rechargeable Li—S cells with high capacities over a large number of cycles.

Most significantly, lithium metal (including pure lithium, lithium alloys of high lithium content with other metal elements, or lithium-containing compounds with a high lithium content; e.g. >80% or preferably >90% by weight Li) still provides the highest anode specific capacity as compared to essentially all other anode active materials (except pure silicon, but silicon has pulverization issues). Lithium metal would be an ideal anode material in a lithium-sulfur secondary battery if dendrite related issues could be addressed.

Sodium metal (Na) and potassium metal (K) have similar chemical characteristics to Li and the sulfur cathode in room temperature sodium-sulfur cells (RT Na—S batteries) or potassium-sulfur cells (K—S) face the same issues observed in Li—S batteries, such as: (i) low active material utilization rate, (ii) poor cycle life, and (iii) low Coulombic efficiency. Again, these drawbacks arise mainly from insulating nature of S, dissolution of S and Na or K polysulfide intermediates in liquid electrolytes (and related Shuttle effect), and large volume change during charge/discharge.

Hence, an object of the present invention is to provide a rechargeable alkali metal battery (e.g., Li—S, Na—S, and K—S battery) that exhibits an exceptionally high specific energy or high energy density. One particular technical goal of the present invention is to provide an alkali metal-sulfur or alkali ion-sulfur cell with a cell specific energy greater than 400 Wh/Kg, preferably greater than 500 Wh/Kg, and more preferably greater than 600 Wh/Kg (all based on the total cell weight).

Another object of the present invention is to provide an alkali metal-sulfur cell that exhibits a high cathode specific capacity (higher than 1,200 mAh/g based on the sulfur weight, or higher than 1,000 mAh/g based on the cathode composite weight, including sulfur, conducting additive or substrate, and binder weights combined, but excluding the weight of cathode current collector). The specific capacity is preferably higher than 1,400 mAh/g based on the sulfur weight alone or higher than 1,200 mAh/g based on the cathode composite weight. This should be accompanied by a high specific energy, good resistance to dendrite formation, and a long and stable cycle life.

It may be noted that in most of the open literature reports (scientific papers) and patent documents, scientists or inventors choose to express the cathode specific capacity based on the sulfur or lithium polysulfide weight alone (not the total cathode composite weight), but unfortunately a large proportion of non-active materials (those not capable of storing lithium, such as conductive additive and binder) is typically used in their Li—S cells. For practical use purposes, it is more meaningful to use the cathode composite weight-based capacity value.

A specific object of the present invention is to provide a rechargeable alkali metal-sulfur cell based on rational materials and battery designs that overcome or significantly reduce the following issues commonly associated with conventional Li—S cells: (a) dendrite formation (internal shorting); (b) extremely low electric and ionic conductivities of sulfur, requiring large proportion (typically 30-55%) of non-active conductive fillers and having significant proportion of non-accessible or non-reachable sulfur or alkali metal polysulfides); (c)dissolution of S and alkali metal polysulfide in electrolyte and then migration of polysulfides from the cathode to the anode (which irreversibly react with lithium, or Na or K at the anode), resulting in active material loss and capacity decay (the shuttle effect); and (d) short cycle life.

### SUMMARY

The present invention provides a sulfur cathode and an alkali metal-sulfur cell (e.g. lithium-sulfur cell, sodium-sulfur cell, and potassium-sulfur cell) comprising such a cathode. The sulfur cathode comprises: (i) a cathode active material layer comprising a resin binder, an optional conductive additive, and multiple particles of a sulfur-containing material selected from a sulfur-carbon hybrid, a sulfur-graphite hybrid, a sulfur-graphene hybrid, a conducting polymer-sulfur hybrid, a metal sulfide, a sulfur compound, or a combination thereof, wherein said sulfur-containing material particles are bonded by said resin binder to form an integral solid layer (or cathode active material layer) bonded to a cathode current collector; and (ii) a cathode-protecting layer, comprising a first high-elasticity polymer, which covers and protects the integral solid layer wherein the first high-elasticity polymer has a recoverable tensile strain no less than 10% (typically from 10% to 1,500%) when measured without an additive or reinforcement, a lithium ion conductivity no less than 106 S/cm at room temperature, and a thickness from 0.5 nm to 100 μm (preferably less than 10 μm) and the first high-elasticity polymer optionally permeates into pores of the cathode active material layer.

The sulfur-carbon hybrid, sulfur-graphite hybrid, sulfur-graphene hybrid, or conducting polymer-sulfur hybrid may be particles of a mixture, blend, composite, or chemically or physically bonded entity of sulfur or sulfide with a carbon, graphite, graphene, or conducting polymer material. For instance, a sulfur-graphene hybrid can be a simple mixture (in a particle form) of sulfur and graphene prepared by ball-milling. Such a hybrid can contain sulfur bonded on surfaces of a graphene oxide sheet, etc. As another example, the sulfur-carbon hybrid can be a simple mixture (in a particle form) of sulfur and carbon nanotubes, or can contain sulfur residing in pores of activated carbon particles.

Individual particles of the sulfur-containing material may be encapsulated by a shell of a second high-elasticity polymer to form particulates (secondary particles), each particulate containing single particle or a small group of multiple particles (e.g., 2-20 particles) protected by a shell. The second high-elasticity polymer has a recoverable tensile strain no less than 10% (typically from 10% to 1,500%) when measured without an additive or reinforcement, a lithium ion conductivity no less than 106 S/cm at room temperature, and a thickness from 0.5 nm to 10 μm and wherein the second high-elasticity polymer is identical to or different than the first high-elasticity polymer.

In certain embodiments, the first or second high-elasticity polymer in the sulfur cathode comprises a rubber or elastomer selected from a non-sulfonated or sulfonated version of natural polyisoprene, synthetic polyisoprene, polybutadiene, chloroprene rubber, polychloroprene, butyl rubber, butyl acrylate rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, crosslinked poly(acrylic acid), acrylic acid-acrylamide copolymer, crosslinked poly(vinylidene fluoride) (PVdF), silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, poly(urethane-urea), poly(ether-urethane), a copolymer thereof, a chemically modified version thereof, or a combination thereof.

The first or second high-elasticity polymer may preferably comprise a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains. The first or second high-elasticity polymer may comprise a cross-linked network of polymer chains selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

Specifically, the first or second high-elasticity polymer preferably comprises a cross-linked network of polymer chains obtained by using a crosslinking agent selected from methyl benzoylformate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium]-hydroxy acrylate) (PKHA), glycerol diglycidyl ether (GDE), ethylene glycol, polyethylene glycol, polyethylene glycol diglycidyl ether (PEGDE), polyethylene glycol methyl ether acrylate (MPEGA), citric acid, acrylic acid, methacrylic acid, a derivative compound of acrylic acid, a derivative compound of methacrylic acid, glycidyl functions, N,N′-Methylenebisacrylamide (MBAAm), Ethylene glycol dimethacrylate (EGDMAAm), isobornyl methacrylate, poly(acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, an ether-urethane chain, a chemical derivative thereof, or a combination thereof.

In certain embodiments, the first or second high-elasticity polymer further comprises a plasticizer or diluent dispersed therein, wherein the plasticizer or diluent is selected from the group consisting of bis(2-methoxyethyl) ether, sulfones, sulfides, dinitriles, acrylonitrile (AN), sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

The first or second high-elasticity polymer preferably further comprises a lithium ion-conducting additive or lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃ (CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In the sulfur cathode for the rechargeable alkali metal-sulfur cell, the metal sulfide may contain a material denoted by MₓS_{y}, wherein x is an integer from 1 to 3 and y is an integer from 1 to 10, and M is a metal element selected from an alkali metal, an alkaline metal selected from Mg or Ca, a transition metal, a metal from groups 13 to 17 of the periodic table, or a combination thereof. The metal element M preferably is selected from Li, Na, K, Mg, Zn, Cu, Ti, Ni, Co, Fe, or Al.

In some preferred embodiments, the metal sulfide in the cathode layer contains Li₂S₁, Li₂S₂, Li₂S₃, Li₂S₄, Li₂S₅, Li₂S₆, Li₂S₇, Li₂S₅, Li₂S₉, Li₂S₁₀, Na₂S₁, Na₂S₂, Na₂S₃, Na₂S₄, Na₂S₅, Na₂S₆, Na₂S₇, Na₂S₈, Na₂S₁₀, Na₂S₁₀, K₂S₁, K₂S₂, K₂S₃, K₂S₄, K₂S₅, K₂S₆, K₂S₇, K₂S₈, K₂S₉, or K₂S₁₀.

The carbon or graphite material in the cathode active material layer may be selected from meso-phase pitch, meso-phase carbon, meso carbon micro-bead (MCMB), coke particle, expanded graphite flake, artificial graphite particle, natural graphite particle, highly oriented pyrolytic graphite, soft carbon particle, hard carbon particle, carbon nanotube, carbon nano-fiber, carbon fiber, graphite nano-fiber, graphite fiber, carbonized polymer fiber, activated carbon, carbon black, or a combination thereof. The graphene may be selected from pristine graphene, graphene oxide, reduced graphene oxide (RGO), graphene fluoride, nitrogenated graphene, hydrogenated graphene, doped graphene, functionalized graphene, or a combination thereof.

The graphene used in the sulfur cathode is preferably selected from pristine graphene, graphene oxide, reduced graphene oxide (RGO), graphene fluoride, nitrogenated graphene, hydrogenated graphene, doped graphene, functionalized graphene, or a combination thereof.

In the sulfur cathode, the conducting polymer-sulfur hybrid may comprise an intrinsically conductive polymer selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, polyfuran, a bi-cyclic polymer, a derivative thereof, a copolymer thereof, a sulfonated version thereof, or a combination thereof.

In certain embodiments, the high-elasticity polymer contains from 0.1% to 50% by weight of a lithium ion-conducting additive dispersed therein, or contains therein from 0.1% by weight to 10% by weight of a reinforcement nano filament selected from carbon nanotube, carbon nano-fiber, graphene, or a combination thereof.

In the sulfur cathode, the sulfur-carbon hybrid, sulfur-graphite hybrid, sulfur-graphene hybrid, or conducting polymer-sulfur hybrid may be a mixture, blend, composite, chemically or physically bonded entity of sulfur or sulfide with a carbon, graphite, graphene, or conducting polymer material.

The first or second high-elasticity polymer may form a mixture or blend with a lithium ion-conducting polymer selected from selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol)diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a sulfonated derivative thereof, or a combination thereof, a sulfonated derivative thereof, or a combination thereof.

Typically, the high-elasticity polymer has a lithium ion conductivity from 1×10⁻⁵ S/cm to 5×10⁻² S/cm at room temperature.

The present disclosure also provides a rechargeable alkali metal-sulfur cell selected from lithium-sulfur cell, sodium-sulfur cell, or potassium-sulfur cell, the alkali metal-sulfur cell comprising: (a) an anode active material layer and an anode current collector supporting the anode active material layer; (b) a sulfur cathode as disclosed herein and a cathode current collector supporting the cathode active material layer; and (c) an electrolyte with an optional separator layer (ion-permeable membrane or solid-state electrolyte layer) in ionic contact with the anode active material layer and the cathode active material layer.

The rechargeable alkali metal-sulfur cell has a sulfur utilization efficiency from 80% to 99%, more typically from 85% to 97%, enabled by the presently disclosed sulfur cathode.

In the rechargeable alkali metal-sulfur cell, the electrolyte is selected from solid polymer electrolyte, gel polymer electrolyte, composite electrolyte, ionic liquid electrolyte, non-aqueous liquid electrolyte, quasi-solid electrolyte, soft matter phase electrolyte, inorganic solid-state electrolyte, or a combination thereof.

The electrolyte may contain a salt selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF₃ (CF₂CF₃)₃), lithium bisperfluoroethysulfonylimide (LiBETI), an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), or a combination thereof.

The solvent may be selected from ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol)dimethyl ether (PEGDME), diethylene glycol dibutyl ether (DEGDBE), 2-ethoxyethyl ether (EEE), sulfone, sulfolane, room temperature ionic liquid, or a combination thereof.

In certain embodiments, the anode active material layer contains an anode active material selected from lithium metal, sodium metal, potassium metal, a lithium metal alloy, sodium metal alloy, potassium metal alloy, a lithium intercalation compound, a sodium intercalation compound, a potassium intercalation compound, a lithiated compound, a sodiated compound, a potassium-doped compound, lithiated titanium dioxide, lithium titanate, lithium manganate, a lithium transition metal oxide, Li₄Ti₅O₁₂, or a combination thereof.

The rechargeable alkali metal-sulfur cell may be a lithium ion-sulfur cell and, in this case, the anode active material layer contains an anode active material selected from the group consisting of: (a) silicon (Si), germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd), and lithiated versions thereof; (b) alloys or intermetallic compounds of Si, Ge, Sn, Pb, Sb, Bi, Zn, Al, or Cd with other elements, and lithiated versions thereof, wherein said alloys or compounds are stoichiometric or non-stoichiometric; (c) oxides, carbides, nitrides, sulfides, phosphides, selenides, and tellurides of Si, Ge, Sn, Pb, Sb, Bi, Zn, Al, Fe, Ni, Co, Ti, Mn, or Cd, and their mixtures or composites, and lithiated versions thereof; (d) salts and hydroxides of Sn and lithiated versions thereof; (c) carbon or graphite materials and prelithiated versions thereof; and combinations thereof.

The rechargeable alkali metal-sulfur cell may be a sodium ion-sulfur cell or potassium ion-sulfur cell and, in this case, the anode active material layer contains an anode active material selected from the group consisting of: (a) Sodium- or potassium-doped silicon (Si), germanium (Gc), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Sodium- or potassium-containing alloys or intermetallic compounds of Si, Ge, Sn, Pb, Sb, Bi, Zn, Al, Ti, Co, Ni, Mn, Cd, and their mixtures; (c) Sodium- or potassium-containing oxides, carbides, nitrides, sulfides, phosphides, selenides, tellurides, or antimonides of Si, Ge, Sn, Pb, Sb, Bi, Zn, Al, Fc, Ti, Co, Ni, Mn, Cd, and mixtures or composites thereof; (d) Sodium or potassium salts; (c) particles of graphite, hard carbon, soft carbon or carbon particles and pre-sodiated versions thereof; and combinations thereof.

Preferably, in the rechargeable alkali metal-sulfur cell, the particulates contain from 80% to 99% by weight of sulfur, metal sulfide, or metal compound based on the total weight of the high-capacity polymer and the sulfur, metal sulfide, or metal compound combined.

In the instant Li—S cell, the reversible specific capacity of the sulfur cathode is typically and preferably no less than 1,000 mAh per gram and often exceeds 1,200 or even 1,500 mAh per gram of entire cathode active layer. The high specific capacity of the presently invented cathode, when combined with a lithium anode, typically leads to a cell specific energy significantly greater than 400 Wh/Kg, based on the total cell weight including anode, cathode, electrolyte, separator, and current collector weights combined. This specific energy value is not based on the cathode active material weight or cathode layer weight only (as sometimes did in open literature or patent applications); instead, this is based on entire cell weight. In many cases, the cell specific energy is higher than 500 Wh/Kg and, in some examples, exceeds 600 Wh/kg.

The invention also provides a method of manufacturing the disclosed sulfur cathode, the method comprising: (A) producing a cathode active material layer by combining a resin binder, an optional conductive additive, and multiple particles of a sulfur-containing material together to form an integral solid layer (cathode active material layer) bonded to a cathode current collector, wherein the sulfur-containing material is selected from a sulfur-carbon hybrid, a sulfur-graphite hybrid, a sulfur-graphene hybrid, a conducting polymer-sulfur hybrid, a metal sulfide, a sulfur compound, or a combination thereof, and wherein the sulfur-containing material particles are bonded by said resin binder and the integral solid layer comprises 5% to 70% by volume of pores; (B) depositing a protective polymer layer onto a primary surface of the integral solid layer to form a protected sulfur electrode, wherein the protective polymer layer comprises a first elastic, ion-conducting polymer having a recoverable tensile strain no less than 10%, when measured without an additive or reinforcement dispersed in the polymer, and a lithium ion conductivity no less than 10⁻⁶ S/cm.

Preferably, the first elastic, ion-conducting polymer permeates into pores of the cathode active layer (integral solid layer).

In certain embodiments, step (B) comprises at least one of the following procedures: (a) dispersing or dissolving the first elastic, ion-conducting polymer in a liquid solvent to form a polymer solution, and spraying, casting, or coating the polymer solution onto a primary surface of the integral solid layer, and removing the liquid solvent to form a dry protective layer; and (b) preparing a liquid reactive mixture comprising a monomer or oligomer, an initiator and/or a crosslinking agent, and depositing the liquid reactive mixture onto a primary surface of the integral solid layer, and polymerizing and/or crosslinking the reactive mixture to form the first elastic, ion-conducting polymer which is in ionic or physical contact with multiple particles of the sulfur-containing material.

In certain embodiments, step (A) comprises producing multiple pores in the integral solid layer (sulfur cathode active layer) and step (B) comprises permeating the first elastic polymer solution or the liquid reactive mixture into the pores and removing the liquid solvent or polymerizing and/or crosslinking the reactive mixture so that the elastic polymer comes in ionic or physical contact with the multiple particles of the sulfur-containing material.

The manufacturing method may further comprise: (a) providing an alkali metal anode, selected from Li, Na, K, or a combination thereof and an anode current collector to support the anode; (b) combining and assembling the alkali metal anode, the sulfur cathode, and a separator or solid-state electrolyte layer, electrically separating the anode and the cathode, and providing a working electrolyte in contact with the anode and the sulfur cathode to form a battery assembly; and (c) encasing the battery assembly in a protective housing to form an alkali metal-sulfur cell.

In some embodiments, as an extra procedure, multiple particles of the sulfur-containing material are encapsulated or embracing with a thin shell of a second high-elasticity polymer using a procedure selected from pan coating, air suspension coating, centrifugal extrusion, vibrational nozzle encapsulation, spray-drying, ultrasonic spraying, coacervation-phase separation, interfacial polycondensation, in-situ polymerization, matrix polymerization, or a combination thereof.

The second high-elasticity polymer may comprise an electronically conductive polymer, a lithium-ion conducting material, a sodium-ion conducting material, a reinforcement material, a conductive additive, or a combination thereof. The lithium ion-conducting material is dispersed in said second high-elasticity polymer and is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃ (CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

Further provided is a method of manufacturing a rechargeable alkali metal-sulfur cell selected from lithium-sulfur cell, sodium-sulfur cell, or potassium-sulfur cell, the method comprising: (a) providing an anode containing an anode active material layer and an optional anode current collector supporting said anode active material layer; (b) providing a sulfur cathode as herein disclosed; (c) providing an electrolyte with an optional separator layer in ionic contact with the anode active material layer and the sulfur cathode layer; and (d) combining the anode, the sulfur cathode, and the electrolyte to form a battery unit and encasing the battery unit in a protective housing to form the rechargeable alkali metal-sulfur cell.

These and other advantages and features of the present invention will become more transparent with the description of the following best mode practice and illustrative examples.

### BRIEF DESCRIPTION OF THE DRAWINGS

FIG. 1(A) Schematic of a prior art alkali metal-sulfur battery cell;

FIG. 1(B) Schematic of another prior art alkali metal-sulfur battery cell;

FIG. 2 The issues associated with the cathode active material of a prior art alkali metal battery; for instance, a metal sulfide particle encapsulated by a protective shell (e.g. carbon shell) in a core-shell structure inevitably leads to breakage of the shell and that a metal sulfide particle encapsulated with a protective layer leads to poor contact between the contracted metal sulfide particle and the rigid protective shell during battery charge.

FIG. 3 Schematic of the presently disclosed alkali metal-sulfur cell featuring an ion-conducting, high-elasticity polymer layer-protected cathode active material layer. The high elastic deformation of the polymer shell enables the protective layer to expand and contract congruently and conformingly with the cathode active layer (when sulfur or polysulfide expand or shrink during repeated battery discharges/charges), according to certain embodiments of the present disclosure.

FIG. 4(A) Schematic of a sulfur-based particle encapsulated by a high-capacity polymer shell to form a core-shell structure and of a lithium polysulfide particle encapsulated by a high-capacity polymer shell to form a core-shell structure.

FIG. 4(B) Schematic of four types of secondary particles comprising a 2^{nd} high-elasticity polymer-embraced primary particles of a S-containing cathode active material in the cathode active material layer; this layer is further protected by a 1^{st} high-elasticity polymer layer.

FIG. 5(A) A flow chart of process for producing a protected sulfur cathode, comprising dispersing or dissolving the first elastic, ion-conducting polymer in a liquid solvent to form a polymer solution, and spraying, casting, or coating the polymer solution onto a primary surface of the integral solid layer, and removing the liquid solvent to form a dry protective layer;

FIG. 5(B) Another process flow chart for producing a protected sulfur cathode comprising preparing a liquid reactive mixture comprising a monomer or oligomer, an initiator and/or a crosslinking agent, and depositing the liquid reactive mixture onto a primary surface of the integral solid layer, and polymerizing and/or crosslinking the reactive mixture to form the first elastic, ion-conducting polymer which is in ionic or physical contact with multiple particles of the sulfur-containing material.

### DETAILED DESCRIPTION

For convenience, the following discussion of preferred embodiments is primarily based on Li—S cells, but the same or similar composition, structure, and methods are applicable to Na—S and K—S cells. Examples are presented for Li—S cells, room-temperature Na—S cells, and K—S cells.

### A. Alkali Metal-Sulfur Cells (Using Lithium-Sulfur Cells as an Example)

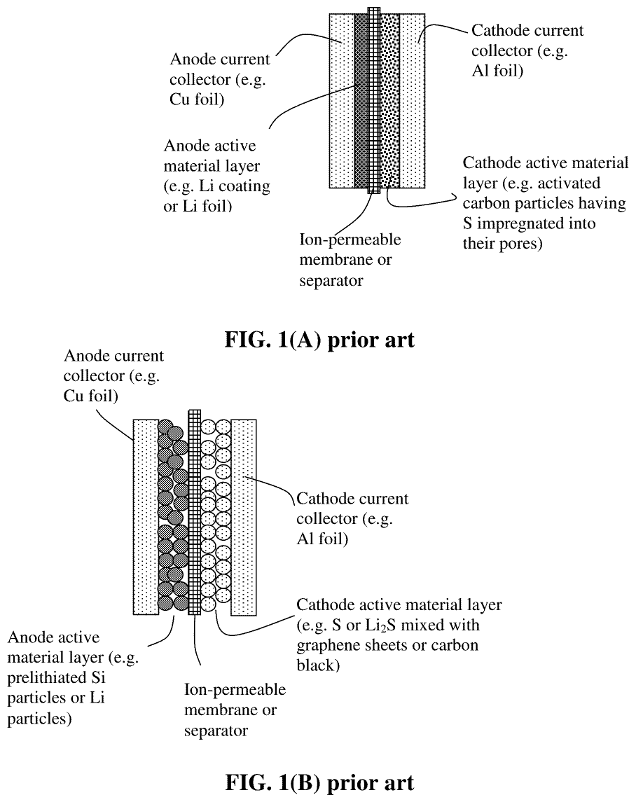

Prior art alkali metal-sulfur batteries are schematically illustrated in FIGS. 1(A) and (B).

The specific capacity and specific energy of a Li—S cell (or Na—S, or K—S cell) are dictated by the actual amount of sulfur that can be implemented in the cathode active layer (relative to other non-active ingredients, such as the binder resin and conductive filler) and the utilization rate of this sulfur amount (i.e. the utilization efficiency of the cathode active material or the actual proportion of S that actively participates in storing and releasing lithium ions).

Using Li—S cell as an illustrative example, a high-capacity and high-energy Li—S cell requires a high amount of S in the cathode active layer (i.e. relative to the amounts of non-active materials, such as the binder resin, conductive additive, and other modifying or supporting materials) and a high S utilization efficiency). The present disclosure provides such a cathode active layer, a high-elasticity polymer layer protecting such a cathode active layer, the resulting Li—S cell, and a method of producing such a cathode active layer and battery.

In certain embodiments, the disclosed sulfur cathode comprises: (i) a cathode active material layer comprising a resin binder, an optional conductive additive, and multiple particles of a sulfur-containing material selected from a sulfur-carbon hybrid, a sulfur-graphite hybrid, a sulfur-graphene hybrid, a conducting polymer-sulfur hybrid, a metal sulfide, a sulfur compound, or a combination thereof, wherein said sulfur-containing material particles are bonded by said resin binder to form an integral solid layer (or cathode active material layer) bonded to a cathode current collector; and (ii) a cathode-protecting layer, comprising a first high-elasticity polymer, which covers and protects the integral solid layer wherein the first high-elasticity polymer has a recoverable tensile strain no less than 10% (typically from 10% to 1,500%) when measured without an additive or reinforcement, a lithium ion conductivity no less than 10⁻⁶ S/cm at room temperature, and a thickness from 0.5 nm to 100 μm (preferably less than 10 μm) and the first high-elasticity polymer optionally permeates into pores of the cathode active material layer.

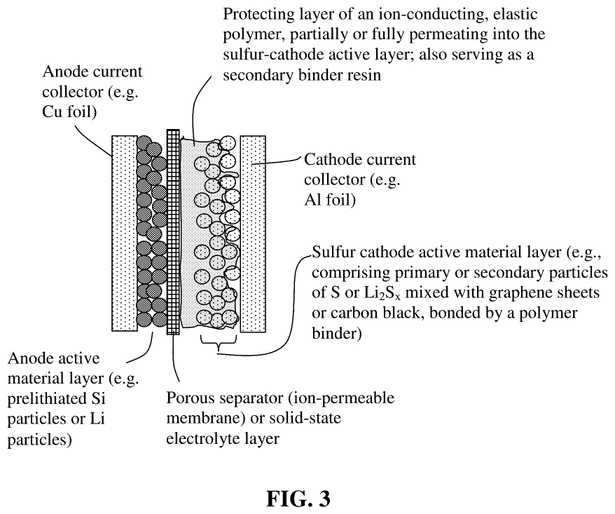

As schematically illustrated in FIG. 3 as an example, the disclosed alkali metal-sulfur cell comprises (a) an anode active material layer and an optional anode current collector supporting the anode active material layer; (b) a sulfur cathode comprising a first elastic polymer-based protecting layer, a cathode active material layer and an optional cathode current collector supporting the cathode active material layer; and (c) a working electrolyte with an ion-permeable membrane (e.g., a porous separator or solid-state electrolyte layer) in ionic contact with the anode active material layer and the cathode active material layer; wherein the cathode active material layer contains multiple particulates of a sulfur-containing material selected from a sulfur-carbon hybrid, sulfur-graphite hybrid, sulfur-graphene hybrid, conducting polymer-sulfur hybrid, metal sulfide, sulfur compound, or a combination thereof. The working electrolyte can permeate deep into the anode active layer and/or cathode active layer making physical and ionic contact with the anode active material and/or cathode active material therein.

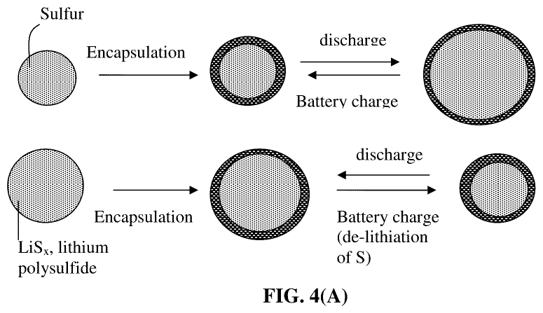

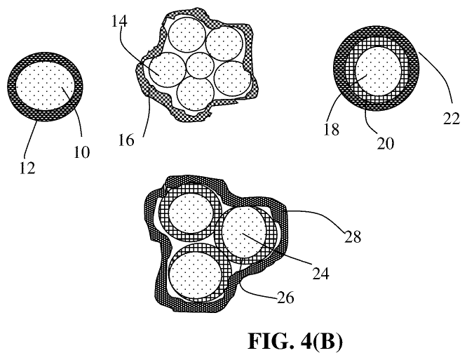

In some embodiments, as schematically illustrated in FIG. 4(B), at least one of the particulates is composed of one or a plurality of the sulfur-containing material particles being embraced or encapsulated by a thin layer of a second high-elasticity polymer having a recoverable tensile strain no less than 10% when measured without an additive or reinforcement, a lithium ion conductivity no less than 10⁻⁵ S/cm (typically from 10⁻⁵ S/cm to 5×10⁻² S/cm, measured at room temperature), and a thickness from 0.5 nm to 10 μm (typically from 1 nm to 1 μm, but preferably <100 nm and more preferably <10 nm). The second high-elasticity polymer may be identical to or different from the first high-elasticity polymer.

The sulfur-carbon hybrid, sulfur-graphite hybrid, sulfur-graphene hybrid, or conducting polymer-sulfur hybrid may be a mixture, blend, composite, or chemically or physically bonded entity of sulfur or sulfide with a carbon, graphite, graphene, or conducting polymer material. For instance, a sulfur-graphene hybrid can be a simple mixture (in a particle form) of sulfur and graphene prepared by ball-milling. Such a hybrid can contain sulfur bonded on surfaces of a graphene oxide sheet, etc. As another example, the sulfur-carbon hybrid can be a simple mixture (in a particle form) of sulfur and carbon nanotubes, or can contain sulfur residing in pores of activated carbon particles.

In certain embodiments, the first or second high-elasticity polymer in the sulfur cathode comprises a rubber or elastomer selected from a non-sulfonated or sulfonated version of natural polyisoprene, synthetic polyisoprene, polybutadiene, chloroprene rubber, polychloroprene, butyl rubber, butyl acrylate rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, crosslinked poly(acrylic acid), acrylic acid-acrylamide copolymer, crosslinked poly(vinylidene fluoride) (PVdF), silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, poly(urethane-urea), poly(ether-urethane), a copolymer thereof, a chemically modified version thereof, or a combination thereof.

In the disclosed rechargeable alkali metal-sulfur cell, the first and/or second high-elasticity polymer may contain a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains. In some preferred embodiments, the high-elasticity polymer contains a cross-linked network of polymer chains selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

Specifically, the first or second high-elasticity polymer preferably comprises a cross-linked network of polymer chains obtained by using a crosslinking agent selected from methyl benzoylformate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), polyethylene glycol methyl ether acrylate (MPEGA), citric acid, acrylic acid, methacrylic acid, a derivative compound of acrylic acid, a derivative compound of methacrylic acid, glycidyl functions, N,N′-Methylenebisacrylamide (MBAAm), Ethylene glycol dimethacrylate (EGDMAAm), isobornyl methacrylate, poly(acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, an ether-urethane chain, a chemical derivative thereof, or a combination thereof.

In certain embodiments, the first or second high-elasticity polymer further comprises a plasticizer or diluent dispersed therein, wherein the plasticizer or diluent is selected from the group consisting of bis(2-methoxyethyl) ether, sulfones, sulfides, dinitriles, acrylonitrile (AN), sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

The first or second high-elasticity polymer preferably further comprises a lithium ion-conducting additive or lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃ (CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLI, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In the rechargeable alkali metal-sulfur cell, the metal sulfide may contain a material denoted by MₓS_{y}, wherein x is an integer from 1 to 3 and y is an integer from 1 to 10, and M is a metal element selected from an alkali metal, an alkaline metal selected from Mg or Ca, a transition metal, a metal from groups 13 to 17 of the periodic table, or a combination thereof. The metal element M preferably is selected from Li, Na, K, Mg, Zn, Cu, Ti, Ni, Co, Fe, or Al. In some preferred embodiments, the metal sulfide in the cathode layer contains Li₂S₁, Li₂S₂, Li₂S₃, Li₂S₄, Li₂S₅, Li₂S₆, Li₂S₇, Li₂S₅, Li₂S₆, Li₂S₁₀, Na₂S₁, Na₂S₂, Na₂S₃, Na₂S₄, Na₂Ss, Na₂S₆, Na₂S₇, Na₂S₈, Na₂S₉, Na₂S₁₀, K₂S₁, K₂S₂, K₂S₃, K₂S₄, K₂S₅, K₂S₆, K₂S₇, K₂S₈, K₂S₉, or K₂S₁₀.

In the rechargeable alkali metal-sulfur cell, the carbon or graphite material in the cathode active material layer may be selected from meso-phase pitch, meso-phase carbon, meso carbon micro-bead (MCMB), coke particle, expanded graphite flake, artificial graphite particle, natural graphite particle, highly oriented pyrolytic graphite, soft carbon particle, hard carbon particle, carbon nanotube, carbon nano-fiber, carbon fiber, graphite nano-fiber, graphite fiber, carbonized polymer fiber, activated carbon, carbon black, or a combination thereof. The graphene may be selected from pristine graphene, graphene oxide, reduced graphene oxide (RGO), graphene fluoride, nitrogenated graphene, hydrogenated graphene, doped graphene, functionalized graphene, or a combination thereof.

In the sulfur cathode, the conducting polymer-sulfur hybrid may comprise an intrinsically conductive polymer selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, polyfuran, a bi-cyclic polymer, a derivative thereof, a copolymer thereof, a sulfonated version thereof, or a combination thereof.

High-elasticity polymer refers to a polymer, typically a lightly cross-linked polymer, which exhibits an clastic deformation that is at least 10% when measured (without an additive or reinforcement in the polymer) under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 30%, more preferably greater than 50%, further more preferably greater than 100%, still more preferably greater than 150%, and most preferably greater than 200%. The preferred types of high-capacity polymers will be discussed later.

As illustrated in FIG. 4(B), the present invention provides four major types of particulates of 2nd high-capacity polymer-encapsulated cathode active material particles. The first one is a single-particle particulate containing a cathode active material core 10 (e.g. particle of a sulfur-CNT mixture) encapsulated by a high-capacity polymer shell 12. The second is a multiple-particle particulate containing multiple cathode active material particles 14 (e.g. particles of sulfur-graphene mixture, sulfur-carbon black mixture, activated carbon particles having pores impregnated with S, lithium polysulfide particles, etc.), optionally along with other active materials (e.g. particles of graphite or hard carbon, not shown) or conductive additive, which are encapsulated by a high-capacity polymer 16. The third is a single-particle particulate containing a cathode active material core 18 coated by a carbon or graphene layer 20 (or other conductive material) and further encapsulated by a high-elasticity polymer 22. The fourth is a multiple-particle particulate containing multiple cathode active material particles 24 coated with a conductive protection layer 26 (carbon, graphene, etc.), optionally along with other active materials (e.g. particles of graphite or hard carbon, not shown) or conductive additive, which are encapsulated by a high-elasticity polymer shell 28. These cathode active material particles can be based on sulfur compound, metal polysulfide, etc., instead of neat sulfur.

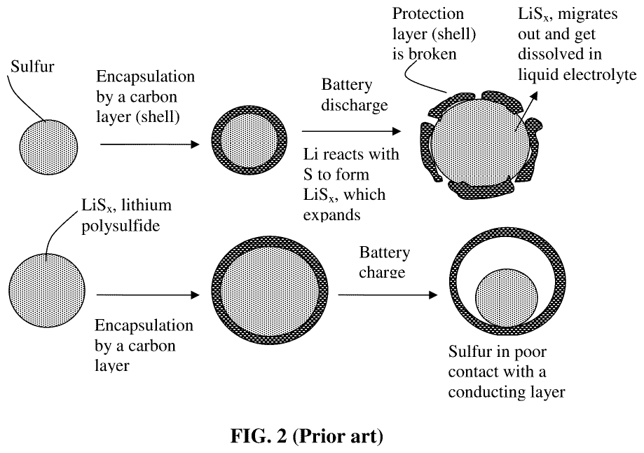

As schematically illustrated in FIG. 2, there are serious issues associated with the cathode active material of a prior art alkali metal battery; for instance, a metal sulfide particle encapsulated by a rigid or brittle protective shell (e.g. carbon shell) in a core-shell structure inevitably leads to breakage of the shell and that a metal sulfide particle encapsulated with a protective layer leads to poor contact between the contracted metal sulfide particle and the rigid protective shell during battery charge.

In contrast, as schematically illustrated in the upper portion of FIG. 4(A), a sulfur-based particle can be encapsulated by a high-capacity polymer shell to form a core-shell structure (sulfur core and polymer shell in this example). As the lithium-sulfur battery is discharged, the cathode active material (e.g. sulfur in the high-capacity polymer-encapsulated S/CNT particle) reacts with lithium ions to form lithium polysulfide which expands in volume. Due to the high elasticity of the encapsulating shell (the high-capacity polymer), the shell will not be broken into segments (in contrast to the broken carbon shell). That the high-capacity polymer shell remains intact, preventing the exposure of the underlying lithium sulfide to electrolyte and, thus, preventing the lithium sulfide from dissolving in the electrolyte during repeated charges/discharges of the battery. This strategy prevents continued migration of lithium polysulfide to the anode side which reacts with lithium and is unable to return to the cathode (the shuttle effect). This shuttle effect is mainly responsible for continued capacity decay in a conventional Li—S, Na—S, or K—S cell.

Alternatively, referring to the lower portion of FIG. 4(A), lithium sulfide is used as the cathode active material. A layer of high-capacity polymer may be encapsulated around the lithium polysulfide particle to form a core-shell structure. When the Li—S battery is charged and lithium ions are released from the cathode, the cathode active material particle contracts. However, the high-capacity polymer is capable of elastically shrinking in a conformal manner; hence, leaving behind no gap between the protective shell and the sulfur. Such a configuration is amenable to subsequent lithium reaction with sulfur. The high-capacity polymer shell expands and shrinks congruently with the expansion and shrinkage of the encapsulated core cathode active material particle, enabling long-term cycling stability of a lithium battery.

A logical question to ask is why a protective layer (comprising the 1^{st} elastic polymer) remains necessary if the sulfur or sulfide particles are already coated with a 2^{nd} elastic polymer. There are multiple reasons for the need to implement such a cathode protective layer:
1) A primary reason is the notion that the electrode volume expansion, induced by the intake of lithium into sulfur to form various lithium polysulfides in the cathode, can and often lead to disintegration of the cathode active layer and delamination of the cathode active layer from the cathode current collector. The protective layer can effectively help to maintain the structural integrity of the cathode and both the ion-conducting and electron-conducting pathways that are essential to the operation of an alkali metal-sulfur layer.
2) Some of the primary particles are not fully encapsulated by the 2nd elastic polymer and the cathode protecting layer can provide an extra layer of protection.
3) The elastic polymers are designed to be positive ion-conducting (permeable to Li⁺, Na⁺, or K⁺ ions), but these polymers are not permeable to larger species, such as sulfur and lithium polysulfide. As such, this protective layer acts to essentially eliminate the shuttling effect, the primary cause of rapid capacity decay in an alkali metal-sulfur battery.

### B. First and Second High-Elasticity Polymers

Preferably and typically, the 1^{st} and 2^{nd} high-capacity polymer has a lithium ion conductivity no less than 10⁻⁵ S/cm, more preferably no less than 10⁻⁴ S/cm, further preferably no less than 10⁻³ S/cm, and most preferably no less than 10⁻² S/cm. In some embodiments, the high-capacity polymer is a neat polymer having no additive or filler dispersed therein. In others, the high-capacity polymer is a polymer matrix composite containing from 0.1% to 50% (preferably 1% to 35%) by weight of a lithium ion-conducting additive dispersed in a high-capacity polymer matrix material. The high-capacity polymer should have a high elasticity (elastic deformation strain value >10%). An elastic deformation is a deformation that is fully recoverable and the recovery process is essentially instantaneous (no significant time delay). The high-capacity polymer can exhibit an elastic deformation from 10% up to 1,000% (10 times of its original length), more typically from 10% to 800%, and further more typically from 50% to 500%, and most typically and desirably from 70% to 300%. It may be noted that although a metal typically has a high ductility (i.e. can be extended to a large extent without breakage), the majority of the deformation is plastic deformation (non-recoverable) and only a small amount of elastic deformation (typically <1% and more typically <0.2%).

In some preferred embodiments, the high-elasticity polymer contains a lightly cross-linked network polymer chains having an ether linkage, nitrile-derived linkage, benzo peroxide-derived linkage, ethylene oxide linkage, propylene oxide linkage, vinyl alcohol linkage, cyano-resin linkage, tri-acrylate monomer-derived linkage, tetra-acrylate monomer-derived linkage, or a combination thereof, in the cross-linked network of polymer chains. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, or a combination thereof.

Typically, a high-elasticity polymer is originally in a monomer or oligomer states that can be cured to form a cross-linked polymer that is highly elastic. Prior to curing, these polymers or oligomers are soluble in an organic solvent to form a polymer solution.

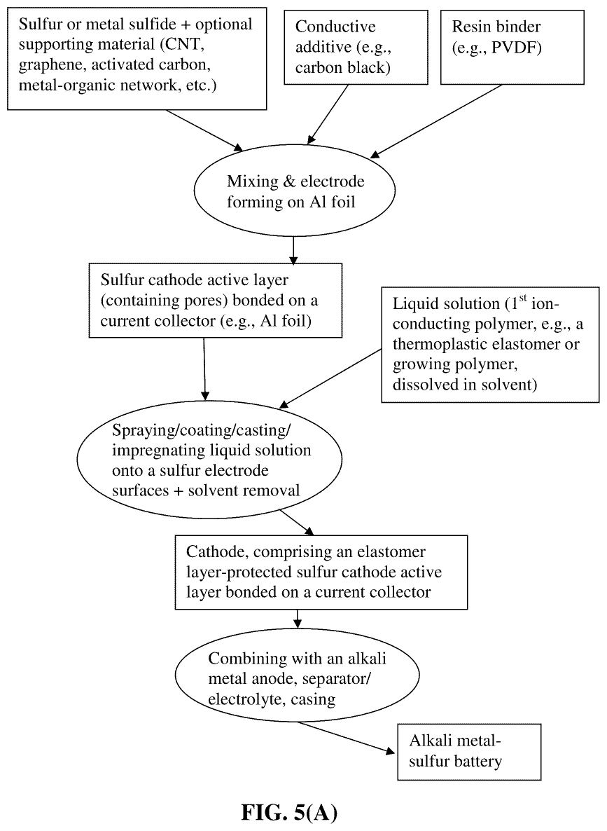

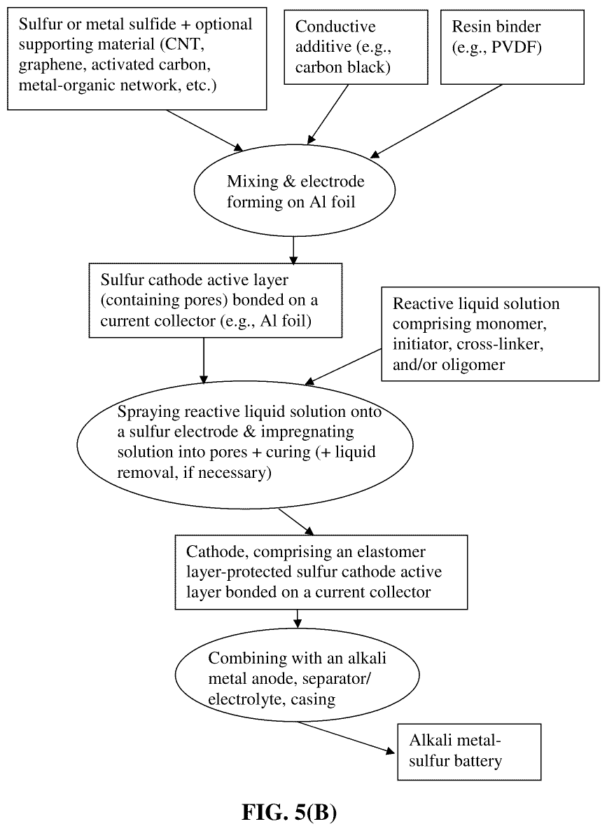

As schematically illustrated in FIGS. 5(A) and (B), the method of manufacturing the disclosed sulfur cathode may comprise: (A) producing a cathode active material layer by combining a resin binder, an optional conductive additive, and multiple particles of a sulfur-containing material together to form an integral solid layer (cathode active material layer) bonded to a cathode current collector, wherein the sulfur-containing material is selected from a sulfur-carbon hybrid, a sulfur-graphite hybrid, a sulfur-graphene hybrid, a conducting polymer-sulfur hybrid, a metal sulfide, a sulfur compound, or a combination thereof, and wherein the sulfur-containing material particles are bonded by said resin binder and the integral solid layer comprises 5% to 70% by volume of pores; (B) depositing a protective polymer layer onto a primary surface of the integral solid layer to form a protected sulfur electrode, wherein the protective polymer layer comprises a first elastic, ion-conducting polymer having a recoverable tensile strain no less than 10%, when measured without an additive or reinforcement dispersed in the polymer, and a lithium ion conductivity no less than 106 S/cm.

Preferably, the first elastic, ion-conducting polymer permeates into pores of the cathode active layer (integral solid layer).

In certain embodiments, step (B) comprises at least one of the following procedures: (a) dispersing or dissolving the first elastic, ion-conducting polymer in a liquid solvent to form a polymer solution, and spraying, casting, or coating the polymer solution onto a primary surface of the integral solid layer, and removing the liquid solvent to form a dry protective layer (FIG. (A)); and (b) preparing a liquid reactive mixture comprising a monomer or oligomer, an initiator and/or a crosslinking agent, and depositing the liquid reactive mixture onto a primary surface of the integral solid layer, and polymerizing and/or crosslinking the reactive mixture to form the first elastic, ion-conducting polymer which is in ionic or physical contact with multiple particles of the sulfur-containing material (FIG. 5(B).

In certain embodiments, step (A) comprises producing multiple pores in the integral solid layer (sulfur cathode active layer) and step (B) comprises permeating the first elastic polymer solution or the liquid reactive mixture into the pores and removing the liquid solvent or polymerizing and/or crosslinking the reactive mixture so that the elastic polymer comes in ionic or physical contact with the multiple particles of the sulfur-containing material.

For particle encapsulation by a 2nd elastic polymer, particles of a cathode active material (e.g. sulfur-carbon hybrid particles, sulfur-graphite hybrid particles, sulfur-graphene hybrid particles, sulfur compound particles, metal sulfide particles, etc.) can be dispersed in this polymer solution to form a suspension (dispersion or slurry) of an active material particle-polymer (monomer or oligomer) mixture. This suspension can then be subjected to a solvent removal treatment while individual particles remain substantially separated from one another.

The polymer (or monomer or oligomer) precipitates out to deposit on surfaces of these active material particles. This can be accomplished, for instance, via spray drying, ultrasonic spraying, air-assisted spraying, aerosolization, and other secondary particle formation procedures.

For instance, ethoxylated trimethylolpropane triacrylate monomer (ETPTA, Mw=428, chemical formula given below), along with an initiator, can be dissolved in an organic solvent, such as ethylene carbonate (EC) or diethyl carbonate (DEC). Then, anode active material particles (Si, Sn, SnO₂, and Co₃O₄ particles, etc.) can be dispersed in the ETPTA monomer/solvent/initiator solution to form a slurry, which can be spray-dried to form ETPTA monomer/initiator-embraced anode particles. These embraced particles can then be thermally cured to obtain the particulates composed of anode particles encapsulated with a thin layer of a high-elasticity polymer. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

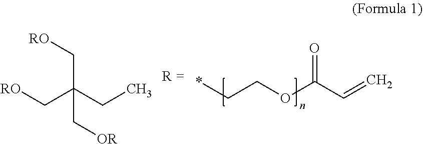

As another example, the high-elasticity polymer for encapsulation may bes based on cationic polymerization and cross-linking of the cyanoethyl polyvinyl alcohol (PVA-CN, Formula 2) in succinonitrile (SN).

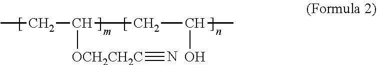

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. Then, particles of a selected anode active material are introduced into the mixture solution to form a slurry. The slurry may then be subjected to a micro-encapsulation procedure to produce anode active material particles coated with an embracing layer of reacting mass, PVA-CN/LiPF₆. These embraced particles can then be heated at a temperature (e.g. from 75 to 100° C.) for 2 to 8 hours to obtain high-elasticity polymer-encapsulated anode active material particles. During this process, cationic polymerization and cross-linking of cyano groups on the PVA-CN may be initiated by PF₅, which is derived from the thermal decomposition of LiPF₆ at such an elevated temperature.

It is essential for these materials to form a lightly cross-linked network of polymer chains. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, ρ is the physical density, R is the universal gas constant in J/mol*K and T is absolute temperature in K. Once Ge and p are determined experimentally, then Mc and the cross-link density can be calculated.

The magnitude of Mc may be normalized by dividing the Me value by the molecular weight of the characteristic repeat unit in the cross-link chain or chain linkage to obtain a number, Nc, which is the number of repeating units between two cross-link points. We have found that the elastic deformation strain correlates very well with Mc and Nc. The elasticity of a cross-linked polymer derives from a large number of repeating units (large Nc) between cross-links. The repeating units can assume a more relax conformation (e.g. random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer for encapsulation may contain a simultaneous interpenetrating network (SIN) polymer, wherein two cross-linking chains intertwine with each other, or a semi-interpenetrating network polymer (semi-IPN), which contains a cross-linked polymer and a linear polymer. An example of semi-IPN is an UV-curable/polymerizable trivalent/monovalent acrylate mixture, which is composed of ethoxylated trimethylolpropane triacrylate (ETPTA) and ethylene glycol methyl ether acrylate (EGMEA) oligomers. The ETPTA, bearing trivalent vinyl groups, is a photo (UV)-crosslinkable monomer, capable of forming a network of cross-linked chains. The EGMEA, bearing monovalent vinyl groups, is also UV-polymerizable, leading to a linear polymer with a high flexibility due to the presence of the oligomer ethylene oxide units. When the degree of cross-linking of ETPTA is moderate or low, the resulting ETPTA/EGMEA semi-IPN polymer provides good mechanical flexibility or elasticity and reasonable mechanical strength. The lithium-ion conductivity of this polymer is typically in the range of 10⁻⁴ to 5×10⁻³ S/cm.

The high-elasticity polymer may form a mixture or blend with an electron-conducting polymer selected from polyaniline, polypyrrole, polythiophene, polyfuran, a bi-cyclic polymer, derivatives thereof (e.g. sulfonated versions), or a combination thereof.

In some embodiments, the high-elasticity polymer may form a mixture with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a derivative thereof (e.g. sulfonated versions), or a combination thereof.

The high-elasticity polymer may form a polymer blend with a conventional elastomer or rubber. Unsaturated rubbers that can be vulcanized to become elastomer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR),

Some elastomers are saturated rubbers that cannot be cured by sulfur vulcanization; they are made into a rubbery or elastomeric material via different means: e.g. by having a copolymer domain that holds other linear chains together. Each of these elastomers can be used to encapsulate particles of an anode active material by one of several means: melt mixing (followed by pelletizing and ball-milling, for instance), solution mixing (dissolving the anode active material particles in an uncured polymer, monomer, or oligomer, with or without an organic solvent) followed by drying (e.g. spray drying), interfacial polymerization, or in situ polymerization of elastomer in the presence of anode active material particles.

Saturated rubbers and related elastomers in this category include EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, and protein elastin. Polyurethane and its copolymers (e.g. urea-urethane copolymer) are particularly useful elastomeric shell materials for encapsulating anode active material particles.

### C. Encapsulation of Cathode Active Material Particles by a 2^{nd} High-Elasticity Polymer

Several micro-encapsulation processes require the high-elasticity polymer or its precursor (monomer or oligomer) to be dissolvable in a solvent. Fortunately, all the high-elasticity polymers or their precursors used herein are soluble in some common solvents. The un-cured polymer or its precursor can be readily dissolved in a common organic solvent to form a solution. This solution can then be used to encapsulate solid particles via several of the micro-encapsulation methods to be discussed in what follows. Upon encapsulation, the polymer shell is then polymerized and cross-linked.

There are three broad categories of micro-encapsulation methods that can be implemented to produce high-elasticity polymer-encapsulated particles of a cathode active material: physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

Pan-coating method: The pan coating process involves tumbling the active material particles in a pan or a similar device while the encapsulating material (e.g. monomer/oligomer, polymer melt, polymer/solvent solution) is applied slowly until a desired encapsulating shell thickness is attained.

Air-suspension coating method: In the air suspension coating process, the solid particles (core material) are dispersed into the supporting air stream in an encapsulating chamber. A controlled stream of a polymer-solvent solution (polymer or its monomer or oligomer dissolved in a solvent; or its monomer or oligomer alone in a liquid state) is concurrently introduced into this chamber, allowing the solution to hit and coat the suspended particles. These suspended particles are encapsulated (fully coated) with a polymer or its precursor molecules while the volatile solvent is removed, leaving a very thin layer of polymer (or its precursor, which is cured/hardened subsequently) on surfaces of these particles. This process may be repeated several times until the required parameters, such as full-coating thickness (i.e. encapsulating shell or wall thickness), are achieved. The air stream which supports the particles also helps to dry them, and the rate of drying is directly proportional to the temperature of the air stream, which can be adjusted for optimized shell thickness.

In a preferred mode, the particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating shell thickness is achieved.

Centrifugal extrusion: Active material particles may be encapsulated using a rotating extrusion head containing concentric nozzles. In this process, a stream of core fluid (slurry containing particles of an material dispersed in a solvent) is surrounded by a sheath of shell solution or melt. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle method: Core-shell encapsulation or matrix-encapsulation of an active material can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the active material. The solidification can be done according to the used gelation system with an internal gelation (e.g. sol-gel processing, melt) or an external (additional binder system, e.g. in a slurry).

Spray-drying: Spray drying may be used to encapsulate particles of an active material when the active material is dissolved or suspended in a melt or polymer solution. In spray drying, the liquid feed (solution or suspension) is atomized to form droplets which, upon contacts with hot gas, allow solvent to get vaporized and thin polymer shell to fully embrace the solid particles of the active material.

Coacervation-phase separation: This process includes three steps carried out under continuous agitation:
(a) Formation of three immiscible chemical phases: liquid manufacturing vehicle phase, core material phase and encapsulation material phase. The core material is dispersed in a solution of the encapsulating polymer (or its monomer or oligomer). The encapsulating material phase, which is an immiscible polymer in liquid state, is formed by (i) changing temperature in polymer solution, (ii) addition of salt, (iii) addition of non-solvent, or (iv) addition of an incompatible polymer in the polymer solution.
(b) Deposition of encapsulation shell material: core material being dispersed in the encapsulating polymer solution, encapsulating polymer material coated around core particles, and deposition of liquid polymer embracing around core particles by polymer adsorbed at the interface formed between core material and vehicle phase; and
(c) Hardening of encapsulating shell material: shell material being immiscible in vehicle phase and made rigid via thermal, cross-linking, or dissolution techniques.

Interfacial polycondensation and interfacial cross-linking: Interfacial polycondensation entails introducing the two reactants to meet at the interface where they react with each other. This is based on the concept of the Schotten-Baumann reaction between an acid chloride and a compound containing an active hydrogen atom (such as an amine or alcohol), polyester, polyurea, polyurethane, or urea-urethane condensation. Under proper conditions, thin flexible encapsulating shell (wall) forms rapidly at the interface. A solution of the active material and a diacid chloride are emulsified in water and an aqueous solution containing an amine and a polyfunctional isocyanate is added. A base may be added to neutralize the acid formed during the reaction. Condensed polymer shells form instantaneously at the interface of the emulsion droplets. Interfacial cross-linking is derived from interfacial polycondensation, wherein cross-linking occurs between growing polymer chains and a multi-functional chemical groups to form an elastomer shell material.

In-situ polymerization: In some micro-encapsulation processes, active materials particles are fully coated with a monomer or oligomer first. Then, direct polymerization and cross-linking of the monomer or oligomer is carried out on the surfaces of these material particles.

Matrix polymerization: This method involves dispersing and embedding a core material in a polymeric matrix during formation of the particles. This can be accomplished via spray-drying, in which the particles are formed by evaporation of the solvent from the matrix material. Another possible route is the notion that the solidification of the matrix is caused by a chemical change.

D. Additional Details about the Encapsulated Particulates, the Cathode Layer, and the Structure of Li—S, Na—S, and K—S cells

The anode active material layer of an alkali metal-sulfur cell can contain a foil or coating of Li, Na, or K supported by a current collector (e.g. Cu foil), as illustrated in the left-hand portion of FIG. 1(A) for a prior art Li—S cell. Alternatively, the anode active material may contain, for instance, particles of pre-lithiated Si particles or surface-stabilized Li particles, as illustrated in the left-hand portion of FIG. 2(B). However, the cathode layer in the instant cell is distinct, as already discussed above.

The electrolyte for an alkali metal-sulfur cell may be an organic electrolyte, ionic liquid electrolyte, gel polymer electrolyte, solid-state electrolyte (e.g. polymer solid electrolyte or inorganic solid electrolyte), quasi-solid electrolyte or a combination thereof. The electrolyte typically contains an alkali metal salt (lithium salt, sodium salt, and/or potassium salt) dissolved in a solvent.

The solvent may be selected from 1,3-dioxolane (DOL), 1,2-dimethoxyethane (DME), tetraethylene glycol dimethylether (TEGDME), poly(ethylene glycol)dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (Y-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium [LiN(CF₃SO₂)₂], lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃ (CF₂CF₃)₃), lithium bisperfluoroethysulfonylimide (LiBETI), an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), and bis-trifluoromethyl sulfonylimide potassium (KN(CF₃SO₂)₂). Among them, LiPF₆, LiBF₄ and LiN(CF₃SO₂)₂ are preferred for Li—S cells, NaPF₆ and LiBF₄ for Na—S cells, and KBF₄ for K—S cells. The content of aforementioned electrolytic salts in the non-aqueous solvent is preferably 0.5 to 3.0 M (mol/L) at the cathode side and 3.0 to >10 M at the anode side.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane) sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation case of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl)imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂, N(COCF₃)(SO₂CF₃)⁻, N(SO₂F)₂⁻, N(CN)₂, C(CN)₃⁻, SCN⁻, SCN⁻, CuCl₂⁻, AlCl₄⁻, F (HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a Li—S cell.

In the presently invented products (including the alkali metal cell, the cathode active layer, and the cathode active material powder), the core material (to be encapsulated by a thin layer of high-elasticity polymer) contains the sulfur-carbon hybrid, sulfur-graphite hybrid, sulfur-graphene hybrid, conducting polymer-sulfur hybrid, metal sulfide, sulfur compound, etc. These hybrid or compound materials are produced in the form of particles that contain a mixture, blend, composite, or bonded entity of sulfur or sulfide with a carbon, graphite, graphene, or conducting polymer material. Metal sulfides (e.g. lithium polysulfide, sodium polysulfide, etc.) and sulfur compounds are readily available in a fine particle form. Sulfur can be combined with a conducting material (carbon, graphite, graphene, and/or conducting polymer) to form a composite, mixture, or bonded entity (e.g. sulfur bonded on graphene oxide surface).

There are many well-known procedures that can be used to make the aforementioned sulfur-containing materials into particles. For instance, one may mix solid sulfur with a carbon or graphite material to form composite particles using ball-milling. The resulting particles are typically ellipsoidal or potato-like in shape having a size from 1 to 20 μm. Also, one may infiltrate S or sulfide into the pores of porous carbon or graphite particles (e.g. activated carbon, meso-porous carbon, activated carbon fibers, etc.) using vapor phase infiltration, solution infiltration, chemical infiltration, or electrochemical infiltration. Alternatively, one may deposit sulfur onto surfaces of graphene sheets, CNTs, carbon nano-fibers, etc. and then form these S-coated nano materials into a spherical or ellipsoidal shape using high-intensity ball-milling, spray-drying (of their suspensions), aerosol formation, etc. These particles are then encapsulated with a high-elasticity polymerusing the micro-encapsulation processes discussed above.

The cathode in a conventional Li—S cell typically has less than 70% by weight of sulfur in a composite cathode composed of sulfur and the conductive additive/support. Even when the sulfur content in the prior art composite cathode reaches or exceeds 70% by weight, the specific capacity of the composite cathode is typically significantly lower than what is expected based on theoretical predictions. For instance, the theoretical specific capacity of sulfur is 1,675 mAh/g. A composite cathode composed of 70% sulfur(S) and 30% carbon black (CB), without any binder, should be capable of storing up to 1,675×70%=1,172 mAh/g. Unfortunately, the observed specific capacity is typically less than 75% or 879 mAh/g (often less than 50% or 586 mAh/g in this example) of what could be achieved. In other words, the active material(S) utilization rate is typically less than 75% (or even <50%). This has been a major issue in the art of Li—S cells and there has been no solution to this problem.

Thus, it is highly advantageous to obtain a high sulfur loading and yet, concurrently, maintaining an ultra-thin/small thickness/diameter of sulfur for significantly enhanced sulfur utilization efficiency, energy density and power density. For instance, one can deposit nano-scaled sulfur (1-5 nm thick) on graphene surfaces using chemical, electrochemical, or vapor deposition to form S-coated or S-bonded graphene sheets. These S-coated or S-bonded graphene sheets are then aggregated together using a tumbling mixing, ball-milling, or spraying procedure. These steps enable the preparation of S-conducting material hybrids that contain 85%-99% by weight sulfur, yet maintaining a coating thickness or particle diameter from 1 nm to 5 nm. This ultra-small dimension enables fast lithium diffusion and lithium-sulfur reactions, leading to high S utilization efficiency (hence, high energy density) even at high charge-discharge rates. By implementing a high-elasticity polymer around these hybrid particles or sulfur compound/sulfide particles, we have significantly reduced and even eliminated the shuttling effect, resulting in an alkali metal battery that has long cycle-life.

Again, the shuttling effect is related to the tendency for sulfur or alkali metal polysulfide that forms at the cathode to get dissolved in the solvent and for the dissolved lithium polysulfide species to migrate from the cathode to the anode, where they irreversibly react with lithium to form species that prevent sulfide from returning back to the cathode during the subsequent discharge operation of the Li—S cell (the detrimental shuttling effect). It appears that the embracing high-elasticity polymer has effectively trapped sulfur and metal polysulfide therein, thereby preventing or reducing such a dissolution and migration issue. We have solved the most critical, long-standing problem of alkali metal-sulfur batteries.

This cathode active material layer may further comprise a binder resin that bonds the multiple particulates (of encapsulated sulfur-containing particles) together to form the cathode active material layer. In the aforementioned cathode active material layer, the binder resin is not part of the multiple particulates (i.e. not included inside the core portion of a particulate) and is external to the multiple particulates. The high-elasticity polymer does not embrace the binder resin and the binder resin is not embedded in the high-elasticity polymer.

In an alternative structure, the cathode active material layer for a rechargeable alkali metal-sulfur cell may contain a resin binder, an optional conductive additive, and multiple particles of a sulfur-containing material, wherein the binder resin helps to bond the sulfur-containing particles together to form a solid layer of structural integrity. This solid layer may be supported by a cathode current collector (e.g. Al foil). This solid layer is covered and protected by a layer of high-elasticity polymer.

In this solid layer, the sulfur-containing material is selected from a sulfur-carbon hybrid, sulfur-graphite hybrid, sulfur-graphene hybrid, conducting polymer-sulfur hybrid, metal sulfide, sulfur compound, or a combination thereof. Again, and more specifically, the sulfur-containing material particles are bonded by the resin binder to form an integral solid layer (a layer of adequate structural integrity so that it can be freely-standing), and the integral solid layer is covered and protected by a thin layer of a high-elasticity polymer having a recoverable tensile strain no less than 10% when measured without an additive or reinforcement, a lithium ion conductivity no less than 10⁻⁵ S/cm at room temperature, and a thickness from 0.5 nm to 10 μm. The integral solid layer may be bonded by the resin binder to a cathode current collector.

Such a high-elasticity polymer protective layer can be formed by spraying the precursor mass (monomer or oligomer with the required initiator or curing agent) over a pre-made cathode active material layer and then polymerized and cross-linked.

The invention also provides a rechargeable alkali metal-sulfur cell that contains such a cathode active material layer, wherein the entire layer is covered and protected by a high-elasticity polymer. This alkali metal-sulfur cell comprises: (a) an anode active material layer and an optional anode current collector supporting the anode active material layer; (b) a cathode that contains this cathode active material layer; and (c) an electrolyte with an optional porous separator layer in ionic contact with the anode active material layer and the cathode active material layer. Effectively, this high-elasticity polymer protective layer is implemented between the cathode active layer and the porous separator.

In all versions of the above-discussed alkali metal-sulfur cells, the anode active material may contain, as an example, lithium metal foil or a high-capacity Si, Sn, or SnO₂ capable of storing a great amount of lithium. The cathode active material may contain pure sulfur (if the anode active material contains lithium), lithium polysulfide, or any sulfur containing compound, molecule, or polymer. If the cathode active material includes lithium-containing species (e.g. lithium polysulfide) when the cell is made, the anode active material can be any material capable of storing a large amount of lithium (e.g. Si, Ge, Sn, SnO₂, etc.).

At the anode side, when lithium metal is used as the sole anode active material in a Li—S cell, there is concern about the formation of lithium dendrites, which could lead to internal shorting and thermal runaway. Herein, we have used two approaches, separately or in combination, to address this dendrite formation issue: one involving the use of a high-concentration electrolyte at the anode side and the other the use of a nano-structure composed of conductive nano-filaments. For the latter, multiple conductive nano-filaments are processed to form an integrated aggregate structure, preferably in the form of a closely packed web, mat, or paper, characterized in that these filaments are intersected, overlapped, or somehow bonded (e.g., using a binder material) to one another to form a network of electron-conducting paths. The integrated structure has substantially interconnected pores to accommodate electrolyte. The nano-filament may be selected from, as examples, a carbon nano fiber (CNF), graphite nano fiber (GNF), carbon nano-tube (CNT), metal nano wire (MNW), conductive nano-fibers obtained by electro-spinning, conductive electro-spun composite nano-fibers, nano-scaled graphene platelet (NGP), or a combination thereof. The nano-filaments may be bonded by a binder material selected from a polymer, coal tar pitch, petroleum pitch, meso-phase pitch, coke, or a derivative thereof.

Nano fibers may be selected from the group consisting of an electrically conductive electro-spun polymer fiber, electro-spun polymer nanocomposite fiber comprising a conductive filler, nano carbon fiber obtained from carbonization of an electro-spun polymer fiber, electro-spun pitch fiber, and combinations thereof. For instance, a nano-structured electrode can be obtained by electro-spinning of polyacrylonitrile (PAN) into polymer nano-fibers, followed by carbonization of PAN. It may be noted that some of the pores in the structure, as carbonized, are greater than 100 nm and some smaller than 100 nm.

The presently invented cathode active layer may be incorporated in one of at least four broad classes of rechargeable lithium metal cells (or, similarly, for sodium metal or potassium metal cells):
(A) Lithium metal-sulfur with a conventional anode configuration: The cell contains an optional cathode current collector, a presently invented cathode layer, a separator/electrolyte, and an anode current collector. Potential dendrite formation may be overcome by using a high-concentration electrolyte or solid-state electrolyte at the anode.
(B) Lithium metal-sulfur cell with a nano-structured anode configuration: The cell contains an optional cathode current collector, a cathode herein invented, a separator/electrolyte, an optional anode current collector, and a nano-structure to accommodate lithium metal that is deposited back to the anode during a charge or re-charge operation. This nano-structure (web, mat, or paper) of nano-filaments provide a uniform electric field enabling uniform Li metal deposition, reducing the propensity to form dendrites. This configuration can provide a dendrite-free cell for a long and safe cycling behavior.
(C) Lithium ion-sulfur cell with a conventional anode: For instance, the cell contains an anode composed of anode active graphite particles bonded by a binder, such as polyvinylidene fluoride (PVDF) or styrene-butadiene rubber (SBR). The cell also contains a cathode current collector, a cathode of the instant invention, a separator/electrolyte, and an anode current collector; and
(D) Lithium ion-sulfur cell with a nano-structured anode: For instance, the cell contains a web of nano-fibers coated with Si coating or bonded with Si nano particles. The cell also contains an optional cathode current collector, a cathode herein invented, a separator/electrolyte, and an anode current collector. This configuration provides an ultra-high capacity, high energy density, and a safe and long cycle life.

In the lithium-ion sulfur cell (e.g. as described in (C) and (D) above), the anode active material can be selected from a wide range of high-capacity materials, including (a) silicon (Si), germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd), and lithiated versions thereof; (b) alloys or intermetallic compounds of Si, Ge, Sn, Pb, Sb, Bi, Zn, Al, or Cd with other elements, and lithiated versions thereof, wherein said alloys or compounds are stoichiometric or non-stoichiometric; (c) oxides, carbides, nitrides, sulfides, phosphides, selenides, and tellurides of Si, Ge, Sn, Pb, Sb, Bi, Zn, Al, Fe, Ni, Co, Ti, Mn, or Cd, and their mixtures or composites, and lithiated versions thereof; (d) salts and hydroxides of Sn and lithiated versions thereof; (e) carbon or graphite materials and prelithiated versions thereof; and combinations thereof. Non-lithiated versions may be used if the cathode side contains lithium polysulfides or other lithium sources when the cell is made.

A possible lithium metal cell may be comprised of an anode current collector, an electrolyte phase (optionally but preferably supported by a porous separator, such as a porous polyethylene-polypropylene co-polymer film), a cathode of the instant invention, and an optional cathode collector.

For a sodium ion-sulfur cell or potassium ion-sulfur cell, the anode active material layer can contain an anode active material selected from the group consisting of: (a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Sodium- or potassium-containing alloys or intermetallic compounds of Si, Ge, Sn, Pb, Sb, Bi, Zn, Al, Ti, Co, Ni, Mn, Cd, and their mixtures; (c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) Sodium or potassium salts; (e) particles of graphite, hard carbon, soft carbon or carbon particles and pre-sodiated versions thereof (pre-doped or pre-loaded with Na), and combinations thereof.

The following examples are presented primarily for the purpose of illustrating the best mode practice of the present invention and should not be construed as limiting the scope of the present invention.

### Example 1: Mixing of Sulfur with Carbon/Graphite Particles Via Ball-Milling to Form Sulfur-Containing Particles

Sulfur particles and particles of soft carbon (i.e. graphitizable disordered carbon), natural graphite, meso-phase carbon, expanded graphite flakes, carbon nano-fibers, and graphene sheets (0% to 95% by weight of S in the resulting composite) were physically blended and then subjected to ball milling for 2-24 hours to obtain S-containing composite particles (typically in a ball or potato shape). Some of the resulting particulates were then made into a layer of cathode.

### Example 2: Simple Sulfur Melt or Liquid Solution Mixing

One way to combine sulfur with a conducting material (e.g. carbon/graphite particles) is to use a solution or melt mixing process. Highly porous activated carbon particles, chemically etched meso-carbon micro-balls (activated MCMBs), and exfoliated graphite worms were mixed with sulfur melt at 177-120° C. (slightly above the melting point of S, 115.2° C.) for 10-60 minutes to obtain sulfur-impregnated carbon particles.

### Example 3: Preparation of Sulfur-Coated Graphene Sheets and their Secondary Particles (Particulates)

The step involves producing vapor of elemental sulfur, allowing deposition of S vapor on surfaces of single-layer or few-layer graphene sheets. The graphene sheets, suspended in a liquid medium (e.g. graphene oxide in water or graphene in NMP), were sprayed onto a substrate (e.g. glass surface) to form a thin layer of graphene sheets. This thin layer of graphene was then exposed to sublimation-generated physical vapor deposition. Sublimation of solid sulfur occurs at a temperature greater than 40° C., but a significant and practically useful sublimation rate typically does not occur until the temperature is above 100° C. We typically used 117-160° C. with a vapor deposition time of 10-120 minutes to deposit a thin film of sulfur on graphene surface (sulfur thickness being approximately from 1 nm to 10 nm). This thin layer of graphene having a thin film of sulfur deposited thereon was then easily broken into pieces of S-coated graphene sheets using an air jet mill. Some of these sheets were made into secondary particles of approximately 5-15 μm in diameter (e.g. via spray-drying) and then used to make sulfur cathode active layers on a cathode current collector (Al foil).

### Example 4: Electrochemical Impregnation of S in Various Porous Carbon/Graphite Particles

The electrochemical impregnation of S into pores of activated carbon fibers, activated carbon nano-tubes, and activated artificial graphite particles was conducted by aggregating these particles/fibers into a loosely packed layer. In this approach, an anode, electrolyte, and a layer of such a loosely packed structure (serving as a cathode layer) are positioned in an external container outside of a lithium-sulfur cell. The needed apparatus is similar to an electro-plating system, which is well-known in the art.

In a typical procedure, a metal polysulfide (MₓS_{y}) was dissolved in a solvent (e.g. mixture of DOL/DME in a volume ratio from 1:3 to 3:1) to form an electrolyte solution. An amount of a lithium salt may be optionally added, but this is not required for external electrochemical deposition. A wide variety of solvents can be utilized for this purpose and there is no theoretical limit to what type of solvents can be used; any solvent can be used provided that there is some solubility of the metal polysulfide in this desired solvent. A greater solubility would mean a larger amount of sulfur can be derived from the electrolyte solution.

The electrolyte solution was then poured into a chamber or reactor under a dry and controlled atmosphere condition (e.g. He or nitrogen gas). A metal foil was used as the anode and a layer of the porous structure as the cathode; both being immersed in the electrolyte solution. This configuration constitutes an electrochemical impregnation and deposition system. The step of electrochemically impregnating sulfur into pores was conducted at a current density in the range of 1 mA/g to 10 A/g, based on the layer weight of the porous carbon/graphite particles/fibers.

The chemical reactions that occur in this reactor may be represented by the following equation: MₓS_{y}→MₓS_{y-z}+zS (typically z=1-4). The sulfur coating thickness or particle diameter and the amount of S coating/particles impregnated may be controlled by the electro-chemical reaction current density, temperature and time. In general, a lower current density and lower reaction temperature lead to a more uniform impregnation of S and the reactions are easier to control. A longer reaction time leads to a larger amount of S saturated in the pores. Additionally, the electrochemical method is capable of rapidly converting the impregnated S into metal polysulfide (lithium polysulfide, sodium polysulfide, and potassium polysulfide, etc.).

### Example 5: Chemical Reaction-Induced Impregnation of Sulfur

A chemical impregnation method was herein utilized to prepare S-impregnated carbon fibers that have been chemically activated. The procedure began with adding 0.58 g Na₂S into a flask that had been filled with 25 ml distilled water to form a Na₂S solution. Then, 0.72 g elemental S was suspended in the Na₂S solution and stirred with a magnetic stirrer for about 2 hours at room temperature. The color of the solution changed slowly to orange-yellow as the sulfur dissolved. After dissolution of the sulfur, a sodium polysulfide (Na₂Sₓ) solution was obtained (x=4-10).

Subsequently, a sulfur-impregnated carbon fiber sample was prepared by a chemical impregnation method in an aqueous solution. First, 180 mg of expansion-treated carbon fibers was suspended in 180 ml ultrapure water with a surfactant and then sonicated at 50° C. for 5 hours to form a stable carbon fiber dispersion. Subsequently, the Na₂Sₓ solution was added to the above-prepared dispersions in the presence of 5 wt % surfactant cetyl trimethyl-ammonium bromide (CTAB), the as-prepared carbon fiber/Na₂Sₓ blended solution was sonicated for another 2 hours and then titrated into 100 ml of 2 mol/L HCOOH solution at a rate of 30-40 drops/min and stirred for 2 hours. Finally, the precipitate was filtered and washed with acetone and distilled water several times to eliminate salts and impurities. After filtration, the precipitate was dried at 50° C. in a drying oven for 48 hours. The reaction may be represented by the following reaction:

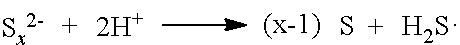

### Example 6: Redox Chemical Reaction-Induced Impregnation of Sulfur in Activated MCMBs and Activated Needle Coke

In this chemical reaction-based deposition process, sodium thiosulfate (Na₂S₂O₃) was used as a sulfur source and HCl as a reactant. An activated MCMB-water or activated needle coke-water suspension was prepared and then the two reactants (HCl and Na₂S₂O₃) were poured into this suspension. The reaction was allowed to proceed at 25-75° C. for 1-3 hours, leading to impregnation of S into pores of the activated structures. The reaction may be represented by the following reaction: 2HCl+Na₂S₂O₃→2NaCl+S↓+SO₂↑+H₂O.

### Example 7: The Ethoxylated Trimethylolpropane Triacrylate Monomer-Derived High-Elasticity Polymer as a Protective Layer for a Sulfur Cathode

In a representative procedure, the ethoxylated trimethylolpropane triacrylate monomer (ETPTA, Mw=428, Sigma-Aldrich) was dissolved in a solvent mixture of ethylene carbonate (EC)/diethyl carbonate (DEC), at a weight-based composition ratios of the ETPTA/solvent of 3/97 (w/w). Subsequently, benzoyl peroxide (BPO, 1.0 wt. % relative to the ETPTA content) was added as a radical initiator to allow for thermal crosslinking reaction after mixing with cathode particles. Then, cathode active material particles (e.g. S-graphene particles) were dispersed in the ETPTA monomer/solvent/initiator solution to form a slurry, which was spray-dried to form ETPTA monomer/initiator-embraced S-graphene particles. These embraced particles were then thermally cured at 60° C. for 30 min to obtain the particulates composed of S-graphene particles encapsulated with a thin layer of a high-elasticity polymer. The ETPTA polymer shell thickness was varied from 1.3 nm to 115 nm. These secondary particles were then mixed with 2% by weight of carbon black and 5% by weight of PVDF binder and all these ingredients were dispersed in NMP to form a slurry. The slurry was coated on an Al foil and dried to form a cathode active layer with pores.

Subsequently, some amount of the ETPTA monomer/solvent/initiator solution was sprayed onto a primary surface of porous cathode active layer. This protective material was allowed to permeate into pores and also form a layer on the cathode active layer. The protective material was then thermally dried and cured at 60° C. for 30 min to form a layer of cross-linked polymer. In this experiment, the BPO/ETPTA weight ratio was varied from 0.1% to 4% to vary the degree of cross-linking in several different polymer films.

Some of the cured polymer samples were subjected to dynamic mechanical testing to obtain the equilibrium dynamic modulus, Ge, for the determination of the number average molecular weight (Mc) between two cross-link points and the corresponding number of repeat units (Nc), as a means of characterizing the degree of cross-linking. Several tensile testing specimens were cut from each cross-link film and tested with a universal testing machine. The representative tensile stress-strain curves of four BPO-initiated cross-linked ETPTA polymers are shown in FIG. 5, which indicate that this series of network polymers have an elastic deformation from approximately 230% to 700%. These data are for neat polymers without any additive. The addition of up to 30% by weight of a lithium salt typically reduces this elasticity down to a reversible tensile strain from 10% to 100%.

### Example 8: Preparation of Cyano-Ethyl Polyvinyl Alcohol-Derived High-Elasticity Polymer

The high-elasticity polymer for encapsulation of several sulfur- and lithium polysulfide-based cathode particles was based on cationic polymerization and cross-linking of the cyanocthyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some lithium species into th high elasticity polymer, we chose to use LiPF₆ as an initiator. The ratio between LiPF₆ and the PVA-CN/SN mixture solution was varied from 1/20 to ½ by weight to form a series of precursor solutions.

Subsequently, particles of a selected cathode active material and their graphene-embraced versions were introduced into these solutions to form a series of slurries. The slurries were then separately subjected to a micro-encapsulation procedure to produce cathode active material particles having entire exterior surfaces being coated with an embracing layer of the reacting mass, PVA-CN/LiPF₆. These embraced particles were then heated at a temperature from 75 to 100° C. for 2 to 8 hours to obtain high-elasticity polymer-encapsulated active material particles. These sulfur-encapsulated secondary particles, in combination with 5% by weight of PVDF-based binder resin, were then made into a porous cathode electrode.

For the formation of a protective layer, the reacting mass, PVA-CN/LiPF₆, was cast onto a surface of the cathode electrode, allowing the reacting mass to migrate into pores of the electrode. The reactive mass was then polymerized and cured to obtain cross-linked polymers having different degrees of cross-linking. Tensile testing was also conducted on these films. This series of cross-linked polymers can be elastically stretched up to approximately 80% (higher degree of cross-linking) to 400% (lower degree of cross-linking).

### Example 9: Preparation of a Protective Layer Featuring a Pentaerythritol Tetraacrylate-Derived High-Elasticity Polymer

For protection of a cathode comprising sulfur-carbon, sulfur-graphite, and sulfur-polymer hybrid particles, pentaerythritol tetraacrylate (PETEA), Formula 3, was used as a monomer:

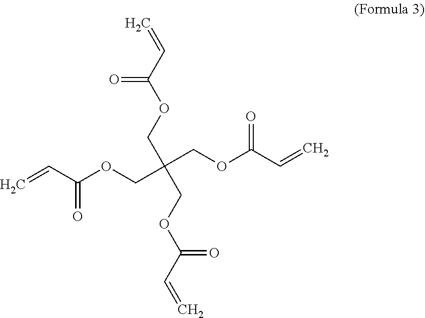 [SMILES: C=CC(=O)OCC(COC(=O)C=C)(COC(=O)C=C)COC(=O)C=C]

The precursor solution was typically composed of 1.5 wt. % of PETEA (C₁₇H₂₀O₈) monomer and 0.1 wt. % of azodiisobutyronitrile (AIBN, C₈H₁₂N₄) initiator dissolved in a solvent mixture of 1,2-dioxolane (DOL)/dimethoxymethane (DME) (1:1 by volume). Different sulfur-based hybrid particles were combined with a binder resin to form a porous cathode active layer. The precursor solution, PETEA/AIBN/solvent precursor solution, was sprayed over a surface of a porous electrode with some reactive liquid permeating into pores and the balance liquid remains on the surface. The precursor solution was polymerized and cured at 70° C. for half an hour to a protective layer composed of high-elasticity polymer-encapsulated particles.

### Example 10: The Preparation of ETPTA-Based High-Elasticity Semi-IPN Polymer

For the encapsulation of the various anode particles by the ETPTA semi-IPN polymer, the ETPTA (Mw=428 g/mol, trivalent acrylate monomer), EGMEA (Mw=482 g/mol, monovalent acrylate oligomer), and 2-hydroxy-2-methyl-1-phenyl-1-propanone (HMPP, a photoinitiator) were dissolved in a solvent (propylene carbonate, PC) to form a reactive solution. The weight ratio between HMPP and the ETPTA/EGMEA mixture was varied from 0.2% to 2%. The ETPTA/EGMEA proportion in the reactive solution was varied from 1% to 5%. The ETPTA/EGMEA ratio in the acrylate mixture was varied from 10/0 to 1/9.

A desired amount of activated carbon was impregnated with sulfur and then made into a porous cathode electrode. This cathode layer supported by an Al foil was dipped into the reactive solution and retreated after 10 minutes. The cathode layer covered by a reacting mass of ETPTA/EGMEA/HMPP was then exposed to UV irradiation for 20 s. The UV polymerization/cross-linking was conducted using a Hg UV lamp (100 W), having a radiation peak intensity of approximately 2000 mW/cm² on the surfaces of the covered cathode layer.

### Example 11: Effect of Lithium Ion-Conducting Additive on Lithium Ion Conductivity of High-Elasticity Polymers

A wide variety of lithium ion-conducting additives were added to several different polymer matrix materials to prepare protective layer materials for protecting sulfur cathodes (Table 1). We have discovered that these polymer composite materials are suitable encapsulation shell materials provided that their lithium ion conductivity at room temperature is no less than 10⁻⁶ S/cm. With these materials, lithium ions appear to be capable of readily diffusing in and out of the encapsulation shell having a thickness no greater than 1 μm. For thicker shells (e.g. 10 μm), a lithium ion conductivity at room temperature no less than 104 S/cm would be required.

TABLE 1
Lithium ion conductivity of various high-elasticity polymer composite compositions
as a shell material for protecting anode active material particles.

| Sample | Lithium-conducting | Elastomer | Li-ion conductivity |
|---|---|---|---|
| No. | additive | (1-2 μm thick) | (S/cm) |
| E-1p | Li₂CO₃ + (CH₂OCO₂Li)₂ | 70-99% PVA-CN | 2.9 × 10⁻⁴ to 3.6 × 10⁻³ S/cm |
| E-2p | Li₂CO₃ + (CH₂OCO₂Li)₂ | 65-99% ETPTA | 6.4 × 10⁻⁴ to 2.3 × 10⁻³ S/cm |
| E-3p | Li₂CO₃ + (CH₂OCO₂Li)₂ | 65-99% ETPTA/EGMEA | 8.4 × 10⁻⁴ to 1.8 × 10⁻³ S/cm |
| D-4p | Li₂CO₃ + (CH₂OCO₂Li)₂ | 70-99% PETEA | 7.8 × 10⁻³ to 2.3 × 10⁻² S/cm |
| D-5p | Li₂CO₃ + (CH₂OCO₂Li)₂ | 75-99% PVA-CN | 8.9 × 10⁻⁴ to 5.5 × 10⁻³ S/cm |
| B1p | LiF + LiOH + Li₂C₂O₄ | 60-90% PVA-CN | 8.7 × 10⁻⁵ to 2.3 × 10⁻³ S/cm |
| B2p | LiF + HCOLi | 80-99% PVA-CN | 2.8 × 10⁻⁴ to 1.6 × 10⁻³ S/cm |
| B3p | LiOH | 70-99% PETEA | 4.8 × 10⁻³ to 1.2 × 10⁻² S/cm |
| B4p | Li₂CO₃ | 70-99% PETEA | 4.4 × 10⁻³ to 9.9 × 10⁻³ S/cm |
| B5p | Li₂C₂O₄ | 70-99% PETEA | 1.3 × 10⁻³ to 1.2 × 10⁻² S/cm |
| B6p | Li₂CO₃ + LiOH | 70-99% PETEA | 1.4 × 10⁻³ to 1.6 × 10⁻² S/cm |
| C1p | LiClO₄ | 70-99% PVA-CN | 4.5 × 10⁻⁴ to 2.4 × 10⁻³ S/cm |
| C2p | LiPF₆ | 70-99% PVA-CN | 3.4 × 10⁻⁴ to 7.2 × 10⁻³ S/cm |
| C3p | LiBF₄ | 70-99% PVA-CN | 1.1 × 10⁻⁴ to 1.8 × 10⁻³ S/cm |
| C4p | LiBOB + LiNO₃ | 70-99% PVA-CN | 2.2 × 10⁻⁴ to 4.3 × 10⁻³ S/cm |
| S1p | Sulfonated polyaniline | 85-99% ETPTA | 9.8 × 10⁻⁵ to 9.2 × 10⁻⁴ S/cm |
| S2p | Sulfonated SBR | 85-99% ETPTA | 1.2 × 10⁻⁴ to 1.0 × 10⁻³ S/cm |
| S3p | Sulfonated PVDF | 80-99% ETPTA/EGMEA | 3.5 × 10⁻⁴ to 2.1 × 10⁻⁴ S/cm |
| S4p | Polyethylene oxide | 80-99% ETPTA/EGMEA | 4.9 × 10⁻⁴ to 3.7 × 10⁻⁴ S/cm |

### Example 12: High-Elasticity Polyrotaxane-Protected Sulfur Cathode

Preparation of a polyrotaxane layer for cathode layer protection was conducted in the following manner: In an example, polyethylene glycol-bisimine (PEG-BA, 0.9 g) and α-CD (3.6 g) were dissolved in water (30 mL) at 80° C. and kept at 5° C. overnight to yield the white paste of the inclusion complex. Then, the paste was dried and added with an excess of 2,4-dinitrofluorobenzene (2.4 mL) together with dimethylformamide (10 mL) and then the mixture was stirred in a nitrogen atmosphere at room temperature overnight. The reaction mixture was dissolved in DMSO (50 mL) and precipitated from a 0.1% sodium chloride aqueous solution (800 mL) twice to give a yellow product. The product was collected, washed with water and methanol (three times, respectively), and dried to produce the polyrotaxane (1.25 g).

Then, polyrotaxane (100 mg) was dissolved in 1 N NaOH (0.5 mL) at 5° C. The hydroxyl groups of α-CD were ionized under a strong base, which resulted in Coulombic repulsion between adjacent CDs in the polyrotaxane. Cyanuric chloride (35 mg), dissolved in 1 N NaOH (0.5 mL), was mixed with the solution to initiate the cross-linking reaction in the resulting solution. The solution was then quickly cast onto a surface of a cathode active layer prepared from the carbon nanofiber/sulfur particles prepared in Example 1. The cross-linking reaction continued. After 3 h at room temperature, a layer of yellow polyrotaxane gel was observed with some polymer gel also permeated into pores of the cathode.

Several tensile testing specimens were prepared from a similarly made film and tested with a universal testing machine. The representative tensile stress-strain curves indicate that this series of network polymers have an elastic deformation from approximately 460% (dry network) to 1,490% (swollen with an organic solvent, EC). These above are for neat polymers without any additive. The addition of up to 30% by weight of a lithium salt typically reduces this elasticity down to a reversible tensile strain from 10% to 100%, but the ion conductivity was significantly increased.

### Example 13: High-Elasticity Polyrotaxane-Protected Sulfur Cathode Active Layer

The high-elasticity polymer as a lithium-protecting layer was based on another rotasane-based network polymer obtained by following a procedure described below. First, CD-based vinylic supramolecular cross-linker (VSC) was prepared by following the procedure described below: An oligomacrocycle and a macromonomer, two constituents of VSCs, were prepared from commercially available starting materials. Oligocyclodextrin (OCD) as the oligomacrocycle was obtained by the controlled reaction of α-cyclodextrin (α-CD) with a polymer diisocyanate derived from polypropylene glycol and tolylene diisocyanate (Schematic C).

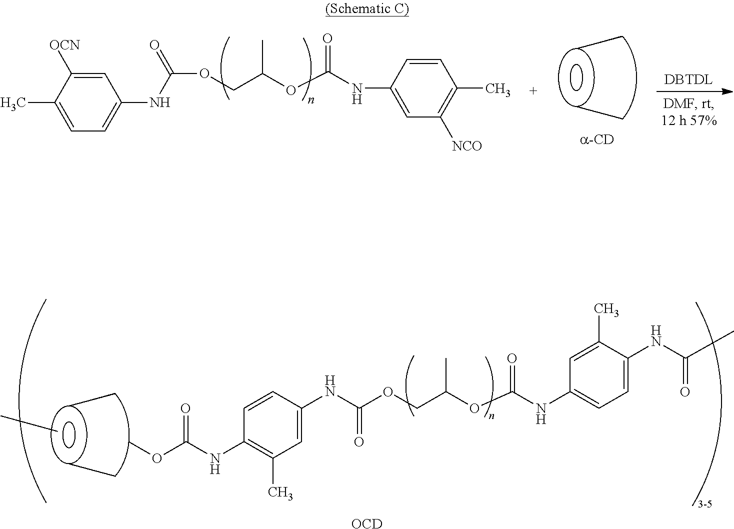

The average number of α-CD per OCD molecule was 4, as calculated from the results of the size-exclusion chromatography (SEC) profile of acetylated OCD (Mw 8000, polydispersity index (PDI) 1.6), which was prepared by using acetic anhydride in pyridine. The macromonomer, a terminal bulky end-tethering polyethylene glycol-type methacrylate (TBM), was prepared by the reaction of a hydroxyl-terminated PEG based macromonomer with 3,5-dimethylphenyl isocyanate (Schematic D).

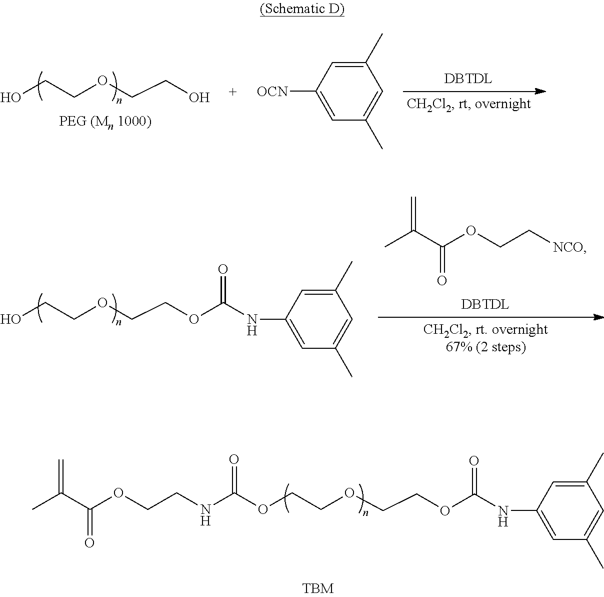

OCD and TBM were mixed in alkaline water (0.1M NaOH), and the mixture was sonicated for 5 min at room temperature to produce a white viscous gel (VSC).

A mixture of N,N-dimethyl-acrylamide (DMAAm, 2.0 g) as a typical vinyl monomer, VSC(0.30 g, 15 wt %), and the photoinitiator (Irgacure-500, 1 wt %) in water were cast onto a primary surface of a cathode active layer prepared from the soft carbon/sulfur particles (Example 1) and UV irradiated at room temperature for 3 min to produce a gelled polymer film (84%, RCP-DMAAm). Water was then removed and some of the cathode layers were impregnated with some organic solvent (e.g. EC).

Tensile testing was also conducted and it was found that this series of cross-linked polymers can be elastically stretched up to approximately 355% (having some lithium salt dispersed therein) or up to 950% (with no additive).

### Example 14: Sulfonation of Triblock Copolymer Poly(Styrene-Isobutylene-Styrene) or SIBS

An example of the sulfonation procedure used in this study is summarized as follows: a 10% (w/v) solution of SIBS (50 g) and a desired amount of graphene oxide sheets (0.15% to 40.5% by wt.) in methylene chloride (500 ml) was prepared. The solution was stirred and refluxed at approximately 40° C., while a specified amount of acetyl sulfate in methylene chloride was slowly added to begin the sulfonation reaction. Acetyl sulfate in methylene chloride was prepared prior to this reaction by cooling 150 ml of methylene chloride in an ice bath for approximately 10 min. A specified amount of acetic anhydride and sulfuric acid was then added to the chilled methylene chloride under stirring conditions. Sulfuric acid was added approximately 10 min after the addition of acetic anhydride with acetic anhydride in excess of a 1:1 mole ratio. This solution was then allowed to return to room temperature before addition to the reaction vessel.

After approximately 5 h, the reaction was terminated by slowly adding 100 ml of methanol. The reacted polymer solution was then precipitated with deionized water. The precipitate was washed several times with water and methanol, separately, and then dried in a vacuum oven at 50° C. for 24 h. This washing and drying procedure was repeated until the pH of the wash water was neutral. After this process, the final polymer yield was approximately 98% on average. This sulfonation procedure was repeated with different amounts of acetyl sulfate to produce several sulfonated polymers with various levels of sulfonation or ion-exchange capacities (IECs). The mol % sulfonation is defined as: mol %=(moles of sulfonic acid/moles of styrene)×100%, and the IEC is defined as the mille-equivalents of sulfonic acid per gram of polymer (mequiv./g).

After sulfonation and washing of each polymer, the S-SIBS samples were dissolved in a mixed solvent of toluene/hexanol (85/15, w/w) with concentrations ranging from 0.5 to 2.5% (w/v). The polymer solution was then coated over a sulfur cathode layer prepared from the activated MCMB/sulfur particles of Example 2.

The following observations were made from the electrochemical testing data of using an alkali metal anode and a protected sulfur cathode:
1) The presently invented approach enables the Li—S, Na—S, and K—S batteries to deliver high cycling stability or long cycle life.
2) The invented approach also leads to alkali metal-sulfur batteries having exceptional energy densities and power densities. A cell-level energy density as high as 605 Wh/kg has been achieved with Li—S cells featuring a cathode active material layer protected by a high-elasticity polymer. Also quite surprisingly, the cell delivers a power density as high as 2875 W/kg, 4-5 times higher than the typical power density of lithium-ion batteries and that of conventional Li—S cells. This power density improvement is very significant in light of the notion that Li—S cells, being conversion-type cells, operate on some chemical reactions during charge/discharge and, hence, typically deliver very low power densities (typically <<500 W/kg).
3) Similar advantageous features are also observed with Na—S cells and K—S cells.

In summary, the present invention provides an innovative, versatile, and surprisingly effective platform materials technology that enables the design and manufacture of superior alkali metal-sulfur rechargeable batteries. The alkali metal-sulfur cell featuring a high-elasticity polymer protected cathode layer containing particulates of sulfur-conducting material hybrid particles encapsulated by exhibits a high cathode active material utilization rate, high specific capacity, high specific energy, high power density, little or no shuttling effect, and long cycle life.

1. A sulfur cathode for a rechargeable alkali metal-sulfur cell, said sulfur cathode comprising:
(i) a cathode active material layer comprising a resin binder and multiple particles of a sulfur-containing material selected from a sulfur-carbon hybrid, a sulfur-graphite hybrid, a sulfur-graphene hybrid, a conducting polymer-sulfur hybrid, a metal sulfide, a sulfur compound, or a combination thereof, wherein said sulfur-containing material particles are bonded by said resin binder to form an integral cathode active layer bonded to a cathode current collector; and
(ii) a cathode-protecting layer, comprising a first high-elasticity polymer, which covers and protects said cathode active layer wherein said high-elasticity polymer has a recoverable tensile strain no less than 10% (typically from 10% to 1,500%) when measured without an additive or reinforcement dispersed therein, a lithium ion or sodium ion conductivity no less than 10⁻⁶ S/cm at room temperature, and a thickness from 0.5 nm to 100 μm (preferably less than 10 μm).

2. The sulfur cathode of claim 1, wherein individual particles of said sulfur-containing material are encapsulated by a shell of a second high-elasticity polymer having a recoverable tensile strain no less than 10% (typically from 10% to 1,500%) when measured without an additive or reinforcement, a lithium ion conductivity no less than 10⁻⁶ S/cm at room temperature, and a thickness from 0.5 nm to 10 μm and wherein the second high-elasticity polymer is identical to or different than the first high-elasticity polymer.

3. The sulfur cathode of claim 1, wherein said first or second high-elasticity polymer comprises a rubber or elastomer selected from a non-sulfonated or sulfonated version of natural polyisoprene, synthetic polyisoprene, polybutadiene, chloroprene rubber, polychloroprene, butyl rubber, butyl acrylate rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, crosslinked poly(acrylic acid), acrylic acid-acrylamide copolymer, crosslinked poly(vinylidene fluoride) (PVdF), silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, poly(urethane-urea), poly(ether-urethane), a copolymer thereof, a chemically modified version thereof, or a combination thereof.

4. The sulfur cathode of claim 1, wherein said first or second high-elasticity polymer comprises a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

5. The sulfur cathode of claim 1, wherein said first or second high-elasticity polymer comprises a cross-linked network of polymer chains selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

6. The sulfur cathode of claim 1, wherein said first or second high-elasticity polymer comprises a cross-linked network of polymer chains obtained by using a crosslinking agent selected from methyl benzoylformate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), polyethylene glycol methyl ether acrylate (MPEGA), citric acid, acrylic acid, methacrylic acid, a derivative compound of acrylic acid, a derivative compound of methacrylic acid, glycidyl functions, N,N′-Methylenebisacrylamide (MBAAm), Ethylene glycol dimethacrylate (EGDMAAm), isobornyl methacrylate, poly(acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, an ether-urethane chain, a chemical derivative thereof, or a combination thereof.

7. The sulfur cathode of claim 1, wherein the first or second high-elasticity polymer further comprises a plasticizer or diluent dispersed therein, wherein the plasticizer or diluent is selected from the group consisting of bis(2-methoxyethyl) ether, sulfones, sulfides, dinitriles, acrylonitrile (AN), sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

8. The sulfur cathode of claim 1, wherein the first or second high-elasticity polymer further comprises a lithium ion-conducting additive or lithium salt dispersed therein and selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃ (CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

9. The sulfur cathode of claim 1, wherein said metal sulfide contains MₓS_{y}, wherein x is an integer from 1 to 3 and y is an integer from 1 to 10, and M is a metal element selected from an alkali metal, an alkaline metal selected from Mg or Ca, a transition metal, a metal from groups 13 to 17 of the periodic table, or a combination thereof.

10. The sulfur cathode of claim 9, wherein said metal element M is selected from Li, Na, K, Mg, Zn, Cu, Ti, Ni, Co, Fe, or Al.

11. The sulfur cathode of claim 1, wherein said metal sulfide contains Li₂S₁, Li₂S₂, Li₂S₃, Li₂S₄, Li₂S₅, Li₂S₆, Li₂S₇, Li₂S₈, Li₂S₉, Li₂S₁₀, Na₂S₁, Na₂S₂, Na₂S₃, Na₂S₄, Na₂S₅, Na₂S₆, Na₂S₇, Na₂S₈, Na₂S₉, Na₂S₁₀, K₂S₁, K₂S₂, K₂S₃, K₂S₄, K₂S₅, K₂S₆, K₂S₇, K₂S₈, K₂S₉, or K₂S₁₀.

12. The sulfur cathode of claim 1, wherein said carbon or graphite material in said cathode active material layer is selected from meso-phase pitch, meso-phase carbon, meso carbon micro-bead (MCMB), coke particle, expanded graphite flake, artificial graphite particle, natural graphite particle, highly oriented pyrolytic graphite, soft carbon particle, hard carbon particle, carbon nanotube, carbon nano-fiber, carbon fiber, graphite nano-fiber, graphite fiber, carbonized polymer fiber, activated carbon, carbon black, or a combination thereof.

13. The sulfur cathode of claim 1, wherein said graphene is selected from pristine graphene, graphene oxide, reduced graphene oxide (RGO), graphene fluoride, nitrogenated graphene, hydrogenated graphene, doped graphene, functionalized graphene, or a combination thereof.

14. The sulfur cathode of claim 1, wherein said conducting polymer-sulfur hybrid contains an intrinsically conductive polymer selected from polyacetylene, polythiophene, poly(3-alkylthiophenes), polypyrrole, polyaniline, polyfuran, a bi-cyclic polymer, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, polyfuran, a bi-cyclic polymer, a derivative thereof, a copolymer thereof, a sulfonated version thereof, or a combination thereof.

15. The sulfur cathode of claim 1, wherein said first or second high-elasticity polymer contains from 0.1% to 50% by weight of a lithium ion-conducting additive dispersed therein, or contains therein from 0.1% by weight to 10% by weight of a reinforcement nano filament selected from carbon nanotube, carbon nano-fiber, graphene, or a combination thereof.

16. The sulfur cathode of claim 1, wherein said sulfur-carbon hybrid, sulfur-graphite hybrid, sulfur-graphene hybrid, or conducting polymer-sulfur hybrid is a mixture, blend, composite, chemically or physically bonded entity of sulfur or sulfide with a carbon, graphite, graphene, or conducting polymer material.

17. The sulfur cathode of claim 1, wherein said first or second high-elasticity polymer forms a mixture or blend with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol)diacrylate, poly(ethylene glycol) methyl ether acrylate, polyurethane, polyurethane-urea, poly(ether urethane), polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a sulfonated derivative thereof, or a combination thereof, a sulfonated derivative thereof, or a combination thereof.

18. The sulfur cathode of claim 1, wherein said first or second high-elasticity polymer has a lithium ion or sodium ion conductivity from 10⁻⁵ S/cm to 5×10⁻² S/cm at room temperature.

19. The sulfur cathode of claim 1, wherein the cathode active material layer further includes a conductive additive.

20. The sulfur cathode of claim 1, wherein said high-elasticity polymer permeates into pores of said cathode active material layer

21. A rechargeable alkali metal-sulfur cell selected from lithium-sulfur cell, sodium-sulfur cell, or potassium-sulfur cell, said alkali metal-sulfur cell comprising:
(a) an anode active material layer and an anode current collector supporting said anode active material layer;
(b) a sulfur cathode of claim 1 and a cathode current collector supporting said cathode active material layer; and
(c) an electrolyte in ionic contact with said anode active material layer and said cathode active material layer.

22. The rechargeable alkali metal-sulfur cell of claim 21, wherein said cell has a sulfur utilization efficiency from 80% to 99%.

23. The rechargeable alkali metal-sulfur cell of claim 21, wherein said electrolyte is selected from solid polymer electrolyte, gel polymer electrolyte, composite electrolyte, ionic liquid electrolyte, non-aqueous liquid electrolyte, quasi-solid electrolyte, soft matter phase electrolyte, inorganic solid-state electrolyte, or a combination thereof.

24. The rechargeable alkali metal-sulfur cell of claim 21, wherein said electrolyte contains a salt selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF₃ (CF₂CF₃)₃), lithium bisperfluoroethysulfonylimide (LiBETI), an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), or a combination thereof.

25. The rechargeable alkali metal-sulfur cell of claim 24, wherein said electrolyte contains a solvent selected from ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (Y-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol)dimethyl ether (PEGDME), diethylene glycol dibutyl ether (DEGDBE), 2-ethoxyethyl ether (EEE), sulfone, sulfolane, room temperature ionic liquid, or a combination thereof.

26. The rechargeable alkali metal-sulfur cell of claim 21, wherein said anode active material layer contains an anode active material selected from lithium metal, sodium metal, potassium metal, a lithium metal alloy, sodium metal alloy, potassium metal alloy, a lithium intercalation compound, a sodium intercalation compound, a potassium intercalation compound, a lithiated compound, a sodiated compound, a potassium-doped compound, lithiated titanium dioxide, lithium titanate, lithium manganate, a lithium transition metal oxide, Li₄ Ti₅O₁₂, or a combination thereof.

27. The rechargeable alkali metal-sulfur cell of claim 21, wherein said cell is a lithium ion-sulfur cell and said anode active material layer contains an anode active material selected from the group consisting of:
(a) silicon (Si), germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd), and lithiated versions thereof;
(b) alloys or intermetallic compounds of Si, Ge, Sn, Pb, Sb, Bi, Zn, Al, or Cd with other elements, and lithiated versions thereof, wherein said alloys or compounds are stoichiometric or non-stoichiometric;
(c) oxides, carbides, nitrides, sulfides, phosphides, selenides, and tellurides of Si, Ge, Sn, Pb, Sb, Bi, Zn, Al, Fe, Ni, Co, Ti, Mn, or Cd, and their mixtures or composites, and lithiated versions thereof;
(d) salts and hydroxides of Sn and lithiated versions thereof;
(e) carbon or graphite materials and prelithiated versions thereof; and
combinations thereof.

28. The rechargeable alkali metal-sulfur cell of claim 21, wherein said cell is a sodium ion-sulfur cell or potassium ion-sulfur cell and said anode active material layer contains an anode active material selected from the group consisting of:
(a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof;
(b) Sodium- or potassium-containing alloys or intermetallic compounds of Si, Ge, Sn, Pb, Sb, Bi, Zn, Al, Ti, Co, Ni, Mn, Cd, and their mixtures;
(c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof,
(d) Sodium or potassium salts;
(e) particles of graphite, hard carbon, soft carbon or carbon particles and pre-sodiated versions thereof; and
combinations thereof.

29. The rechargeable alkali metal-sulfur cell of claim 21, wherein said particulates contain from 80% to 99% by weight of sulfur, metal sulfide, or metal compound based on the total weight of said high-capacity polymer and said sulfur, metal sulfide, or metal compound combined.

30. The rechargeable alkali metal-sulfur cell of claim 21, further including a porous separator layer in said electrolyte.

31.-38. (canceled)
